(19) United States
(12) Patent Application Publication
(10) Pub. No.: US 2024/0046174 A1
(43) Pub. Date: Feb. 8, 2024

(54) TARGET MANAGEMENT SYSTEM, TARGET MANAGEMENT METHOD, AND NON-TRANSITORY STORAGE MEDIUM

(71) Applicant: Panasonic Intellectual Property Management Co., Ltd., Osaka (JP)

(72) Inventors: Tomokazu ICHIRIKI, Kanagawa (JP); Mayumi AKIDUKI, Tokyo (JP); Momo KOINUMA, Tokyo (JP)

(73) Assignee: Panasonic Intellectual Property Management Co., Ltd., Osaka (JP)

(21) Appl. No.: 18/381,445

(22) Filed: Oct. 18, 2023

Related U.S. Application Data
(63) Continuation of application No. PCT/JP2022/024378, filed on Jun. 17, 2022.

(30) Foreign Application Priority Data
Jul. 16, 2021 (JP) 2021-118286

(51) Int. Cl. G06Q 10/0631; G06Q 10/0639

(52) U.S. Cl. CPC G06Q 10/063116; G06Q 10/06398

(57) ABSTRACT

A target management system includes: an acquirer that acquires, over a first period including time frames when operations are performed, an actual value of man-hour of each of the operations; and a processor that calculates a difference between the actual value of the man-hour of each of the operations for the first period and a preset standard man-hour and updates the standard man-hour to narrow the difference in a second period following the first period. The processor acquires, with respect to the same item of operation as the man-hour acquired in the first period, a predicted man-hour value for the second period based on a prediction dataset including period identification information, period attribute information, and quantity information. The processor creates an operation plan for the second period based on the standard man-hour updated, the predicted man-hour value, and personnel information about personnel who performs the operations in the second period.

### CROSS-REFERENCE TO RELATED APPLICATIONS

The present application is a Bypass Continuation of International Application No. PCT/JP2022/024378 filed on Jun. 17, 2022, which is based upon, and claims the benefit of priority to, Japanese Patent Application No. 2021-118286, filed on Jul. 16, 2021. The entire contents of both applications are hereby incorporated by reference.

### TECHNICAL FIELD

The present disclosure generally relates to a target management system, a target management method, and a non-transitory storage medium. More particularly, the present disclosure relates to a target management system, target management method, and non-transitory storage medium, all of which are used to manage the activity of an organization using a target such as man-hour or profits.

### BACKGROUND ART

JP 2020-19588 A discloses a shelf inventory management system for calculating, on a shelf of products basis, the number of products, which remain in stock on the shelf of products (hereinafter referred to as “in-stock products”), based on the distance measured by a measuring module using an ultrasonic wave. The ultrasonic wave is emitted from an ultrasonic sensor installed behind the shelf of products. This system compares the number of in-stock products thus calculated with a predetermined threshold value, thereby determining whether the shelf needs to be stocked. If a decision is made that there be any shelf of products that needs shelf stocking, the salesclerk is informed of that. In addition, the salesroom inside the store is shot by an image capturing means. When a person is detected based on the image thus captured, the trajectory of movement of the person inside the store is obtained based on the image.

According to the known art, however, the difference between the value calculated based on the distance measured by the measuring module with respect to a target such as the number of in-stock products and a standard value such as the predetermined threshold value sometimes widens so significantly as to make it difficult to appropriately manage an activity such as shelf stocking (e.g., determine whether the shelves need to be stocked) using the target.

### SUMMARY

The present disclosure provides a target management system, a target management method, and a non-transitory storage medium, all of which contribute to appropriately managing an activity using a target.

A target management system according to an aspect of the present disclosure includes an acquirer and a processor. The acquirer acquires, over a first period including a plurality of time frames in which a plurality of operations are performed, an actual value of man-hour of each of the plurality of operations. The processor calculates a difference between the actual value of the man-hour of each of the plurality of operations to be performed in the first period and a preset standard man-hour and updates the standard man-hour to narrow the difference in a second period following the first period. The processor acquires, with respect to an item of operation identical with the man-hour acquired in the first period, a predicted man-hour value for the second period based on a dataset for prediction including period identification information, period attribute information, and quantity information. The processor creates an operation plan for the second period based on the standard man-hour that has been updated, the predicted man-hour value, and personnel information about personnel including a worker who performs the plurality of operations in the second period.

A target management method according to another aspect of the present disclosure includes an acquisition step and a processing step. The acquisition step includes acquiring, over a first period including a plurality of time frames, a value of man-hour of each of a plurality of operations. The processing step includes calculating a difference between an actual value of the man-hour of each of the plurality of operations to be performed in the first period and a preset standard man-hour and updating the standard man-hour to narrow the difference in a second period following the first period. The processing step also includes acquiring, with respect to an item of operation identical with the man-hour acquired in the first period, a predicted man-hour value for the second period based on a dataset for prediction including period identification information, period attribute information, and quantity information. The processing step further includes creating an operation plan for the second period based on the standard man-hour that has been updated, the predicted man-hour value, and personnel information about personnel including a worker who performs the plurality of operations in the second period.

A non-transitory storage medium according to still another aspect of the present disclosure stores thereon a program designed to cause one or more processors to perform the target management described above.

### BRIEF DESCRIPTION OF DRAWINGS

The figures depict one or more implementations in accordance with the present teaching, by way of example only, not by way of limitations. In the figures, like reference numerals refer to the same or similar elements.

FIG. 1 is a block diagram of a target management system according to a first embodiment of the present disclosure;

FIG. 2 is a flowchart illustrating how the target management system operates;

FIG. 3 is a flowchart illustrating how the target management system performs narrowing processing;

FIG. 4 is a block diagram of a shelf stocking management system according to a second embodiment of the present disclosure;

FIG. 5 shows exemplary pieces of shelf stocking related information (headquarters top image, which is an image providing various pieces of shelf stocking related information at multiple stores) which may be output by a shelf stocking management device of the shelf stocking management system;

FIG. 6 shows exemplary pieces of shelf stocking related information (an image showing store-by-store days of inventory on hand) which may be output by the shelf stocking management device;

FIG. 7 shows exemplary pieces of shelf stocking related information (an image showing store-by-store operation efficiency) which may be output by the shelf stocking management device;

FIG. 8 is a block diagram of a plan optimization system according to a third embodiment of the present disclosure;

FIG. 9 is a block diagram illustrating how a creator and a predictor which form the plan optimization system make prediction;

FIG. 10A shows a data structure of work record information for use by the creator and the predictor to make the prediction;

FIG. 10B shows a data structure of work schedule information that constitutes an operation plan to be created based on a result of the prediction;

FIG. 11 is a conceptual diagram illustrating an exemplary application of the target management system to physical distribution; and

FIG. 12 is a conceptual diagram illustrating an exemplary application of the target management system to selling activities.

### DETAILED DESCRIPTION

Note that the embodiments to be described below are only exemplary ones of various embodiments of the present disclosure and should not be construed as limiting. Rather, the exemplary embodiments may be readily modified in various manners depending on a design choice or any other factor without departing from the scope of the present disclosure.

### (1) Common feature of First, Second, and Third Embodiments

A principal feature of a target management system according to the present disclosure is to appropriately manage an activity using a target by performing, either only once or repeatedly, “visualization” by acquiring a value of a target in a recognizable form, “standardization” by setting a standard value, and “gap narrowing” by performing narrowing processing to narrow the difference between the visualized value and the standard value.

According to the present disclosure, acquisition of a value, setting a standard value, and processing to narrow the difference are performed either only once or repeatedly with special attention paid to the fact that the wider the difference between the acquired value and the standard value is, the higher the chances of at least one of the activity or the standard value being improper is. As a result, the difference is narrowed either at once or gradually to allow at least one of the improper activity or the improper standard value to be redressed either at once or gradually. This allows the activity to be managed appropriately using a target.

A target management system according to the present disclosure includes an acquirer, a setter, and a narrowing processor.

Note that each of a target management system 100 according to a first embodiment, a shelf stocking management system 100A according to a second embodiment, and a plan optimization system 100B according to a third embodiment is an exemplary form of the target management system.

### (1-1) Acquisition of Value of Target

The acquirer acquires a value of a target with respect to each of one or more first periods.

As used herein, the “target” refers to a parameter to be used by the target management system for management purposes and is a piece of information about the activity of either personnel or an organization to which the personnel belongs. As used herein, “personnel” refers to at least one person who performs the activity. Examples of the organization to which the personnel belongs include business enterprises and groups. The activity is usually carried out by personnel belonging to an organization. However, the activity may also be carried out by personnel not belonging to any organization. Also, the number of personnel belonging to an organization is usually two or more but may also be one.

The “activity” may be, for example, any one of operations, management, or business management or a combination thereof. The activity as used herein refers to a commercial activity performed by a business enterprise and usually includes operations, management, and business management. However, this is only an example and should not be construed as limiting. The activity may also be a non-commercial activity performed by a non-profit organization. The non-commercial activity usually includes operations and management but does not include business management.

Optionally, the organization may be hierarchized into two or more layers. For example, the two or more layers may be two layers consisting of a low-order layer and a high-order layer. The low-order layer may be a field layer and the high-order layer may be a business management layer.

Alternatively, the two or more layers may be three layers consisting of a low-order layer, an intermediate layer, and a high-order layer. The intermediate layer may be a field management layer (management layer).

The field layer may be further divided into, for example, a store layer, a division layer lower in order than the store layer, and a team layer lower in order than the division layer. Nevertheless, the field layer may or may not be hierarchized. In the former case, the hierarchy may consist of any number of layers (i.e., may have any hierarchical depth) without limitation.

Also, the organization usually consists of two or more departments, each of which belongs to any one of two or more layers. Examples of the two or more departments include a physical distribution department, a selling department, a management department, and a business management department. The physical distribution department and the selling department belong to the field layer. The management department belongs to the field management layer. The business management department belongs to the business management layer.

A “target” as used herein refers to a piece of information indicating, in a recognizable form, the activity status. The “recognition” as used herein usually refers to recognition by a human being. Optionally, the recognition may also refer to recognition by a computer that substitutes human intellectual activity by mechanical processing.

The target may be, for example, a piece of operation information. As used herein, the “operation information” refers to a piece of information about operations. Examples of the operation information include a man-hour, the quantity of inventory, and operation efficiency.

The man-hour, the quantity of inventory, and the operation efficiency will be described in detail later.

Alternatively, the target may also be a piece of business management information. As used herein, the “business management information” refers to a piece of information about business management. Examples of the business management information include management indicators such as profits and growth rate.

Still alternatively, the target may also be field management information. As used herein, the “field management information” refers to a piece of information about field management. Examples of field management include operations management and cost management.

Optionally, the target may be associated with hierarchical layer identification information. As used herein, the “hierarchical layer identification information” refers to a piece of information for use to identify a hierarchical layer. The hierarchical layer identification information may be, for example, the name of the hierarchical layer such as “business management layer” or “field layer.” Alternatively, the hierarchical layer identification information may also be an ID corresponding to the name of the hierarchical layer.

The target may also be associated with department identification information. As used herein, the “department identification information” refers to a piece of information for use to identify the department. The department identification information may be, for example, the name of the department such as “selling department” or “physical distribution department.” Alternatively, the department identification information may also be an ID corresponding to the name of the department.

Furthermore, the target may also be associated with personnel identification information. As used herein, the “personnel identification information” refers to information for use to identify the personnel. The personnel identification information may be, for example, the name, address, and cellphone number of the personnel. Alternatively, the personnel identification information may also be an ID corresponding to the name, address, and other personal information.

The acquirer acquires a value of the target based on one or more pieces of information selected from the group consisting of information provided by a sensor (result of observation), information entered manually through an input device such as a keyboard or a touchscreen panel, and information stored in a memory. Note that the value acquired by the acquirer via the sensor is an actual value. Optionally, the acquirer may receive a predicted value from a predictor (to be de scribed later).

The sensor may be, for example, either a camera 3 or a local positioning system (LPS) 4 or an observation system including the camera 3 and the LPS 4. The camera 3 is installed on the spot where operations are performed (hereinafter simply referred to as a “spot”) to shoot a target of the operations (hereinafter referred to as an “operation target”) and personnel who are performing the operations (such as a salesclerk or a worker). The LPS 4 is installed on the spot to detect the locations of the personnel (or articles) on the spot. The LPS 4 will be described in detail later for the third embodiment. Alternatively, the sensor may also be, for example, a barcode scanner for reading a barcode affixed to a product.

The memory is usually a memory built in the target management system but may also be an external memory. The memory may be located anywhere as long as a computer of the target management system may access the memory.

Note that the acquirer according to the first embodiment is an acquirer 121. The acquirer according to the second embodiment is an information generator 121A. The acquirer according to the third embodiment is an observer 221.

### (1-2) Setting of Standard Value

The setter sets a standard value for the target

As used herein, the “standard value” refers to a standard value with respect to a target. The standard value is a value to be used as a criterion for determining whether the value acquired with respect to the target is good or bad, or high or low (e.g., whether the efficiency is good or bad or whether the profits are high or low). Examples of the standard value include a threshold value, an ideal value, and an evaluation index. For example, if the target is man-hour, then the standard value is a standard man-hour.

Note that the setter according to the first embodiment is a setter 122. The setter according to the second embodiment is a processor 12A. The setter according to the third embodiment is a setter 123B.

### (1-3) Difference Narrowing

The narrowing processor performs narrowing processing.

As used herein, the “narrowing processing” refers to the processing to narrow, either at once or gradually, the difference between the standard value and a value acquired in one or more second periods following the one or more first periods. Note that the one or more first periods are usually one or more periods in the past, while the one or more second periods are usually one or more periods in the future.

Nevertheless, the one or more first periods are not necessarily periods in the past for the present as long as the one or more first periods are anterior to the one or more second periods. Also, the one or more second periods are not necessarily periods in the future for the present as long as the one or more second periods are posterior to the one or more first periods.

The difference may be, for example, the difference between the value acquired by the acquirer (which may be the acquirer 121, the information generator 121A, or the observer 221) and the standard value. Alternatively, the difference may also be the difference between a predicted value acquired by the predictor (to be described later) and the standard value.

Note that the narrowing processor according to the first embodiment is a narrowing processor 124. The narrowing processor according to the second embodiment is the processor 12A. The narrowing processor according to the third embodiment is a processor 12B.

### (1-4) Type of Narrowing Processing

The narrowing processing includes either or both of output control and optimization. Nevertheless, at least part of the output control may be means for realizing optimization with human hands.

Note that according to the first embodiment, both the output control and optimization are carried out as the narrowing processing. According to the second embodiment, the output control is carried out as the narrowing processing. According to the third embodiment, the optimization is carried out as the narrowing processing.

### (1-4-1) Output Control

The output control herein refers to a type of control for having the difference output in a recognizable form.

Making the personnel recognize the output difference and change their activity enables narrowing the difference either at once or gradually and thereby redressing the improper activity either at once or gradually. This allows the activity to be managed appropriately.

### (1-4-2) Optimization

The optimization according to the present disclosure includes either or both of updating the standard value (such as a standard man-hour) and updating the predicted value (such as predicted man-hour).

### (1-4-2a) Optimization #1: update of Standard Value

Updating a standard value either at once or gradually to narrow, either at once or gradually, the difference between the acquired value and the standard value with respect to a target allows the improper standard value to be redressed either at once or gradually. This allows the activity to be managed appropriately using the target.

Note that updating the standard value also contributes to optimizing the information (such as an operation plan) to be created using the standard value.

It is preferable that the update of the standard value be performed along with either the output control described above or the update of the predicted value (to be described later). This contributes to redressing both the improper activity and the improper standard value. In addition, this also reduces the chances of the improper activity becoming a standard activity compared to updating only the standard value.

### (1-4-2b) Optimization #2: Update of Predicted Value

Updating, when acquiring a predicted value as the value of the target, the predicted value either at once or gradually to narrow the difference between the acquired value and the standard value either at once or gradually brings the acquired value closer to the standard value either at once or gradually. This allows the activity to be managed appropriately using the target.

Note that updating the predicted value also contributes to optimizing the information (such as an operation plan) to be created using the predicted value. (

### 1-4-2c) Optimization #3: Change of Plan

Changing the activity plan (such as operation plan) to narrow the difference between the acquired value and the standard value with respect to a target either at once or gradually allows the activity to be managed appropriately using the target.

### (1-4-2d) Optimization #4: Change of Series of Process Steps

Changing a series of process steps (such as a series of operation process steps) to narrow the difference between the acquired value and the standard value with respect to a target either at once or gradually allows the activity to be managed appropriately using the target.

### (2) Common feature of first and second embodiments

### (2-1) Output Control

The narrowing processor (narrowing processor 124, processor 12A) includes an output controller. The output controller has the difference output in a recognizable form.

Note that the output controller according to the first embodiment is an output controller 1241. The output controller according to the second embodiment is a first output controller 122A and a second output controller 123A.

According to this aspect, making the personnel recognize the output difference and change their activity allows the difference to be narrowed either at once or gradually, thereby redressing the improper activity either at once or gradually. This allows the activity to be managed appropriately.

The output controller (output controller 1241, first output controller 122A, second output controller 123A) includes a first output controller and a second output controller.

### (2-1-1) First Output Control

The first output controller has an acquired value that is the value acquired by the acquirer (acquirer 121, information generator 121A) output. In addition, the first output controller usually has target identification information output as well.

As used herein, the “target identification information” refers to a piece of information for use to identify a target. The target identification information is a character string representing the name of the target such as “man-hour” or “profits” or an ID corresponding to the name of the target.

Note that the first output controller according to the first embodiment is a first output controller 1241a. The first output controller according to the second embodiment is the first output controller 122A.

This makes it easier to recognize the acquired value.

### (2-1-2) Second Output Control

The second output controller has a result of comparison between the acquired value and the standard value output in a recognizable form.

Note that the second output controller according to the first embodiment is a second output controller 1241b. The second output controller according to the second embodiment is the second output controller 123A.

This makes it easier to compare the acquired value and the standard value.

This also allows the activity to be managed appropriately and easily using a target based on the results of the first output control and the second output control.

### (3) Feature Unique to Second Embodiment

According to the second embodiment, the organization includes a store 200. In the store 200, they sell products.

The target is a piece of information about shelf stocking in the store 200. The standard value is an evaluation index of information about shelf stocking.

The first output controller 122A has shelf stocking related information output. As used herein, the “shelf stocking related information” refers to a piece of information about shelf stocking and is information generated by the information generator 121A.

The second output controller 123A has a result of comparison between the shelf stocking related information and the evaluation index output in a recognizable form.

This makes it easier to make evaluation about shelf stocking. As a result, the shelf stocking may be managed appropriately and easily based on the shelf stocking related information.

### (4) Common Feature of First and Third Embodiments

### (4-1) Difference Detection

The target management system (100, plan optimization system 100B) further includes a detector. The detector detects a difference between the acquired value acquired by the acquirer (121, observer 221) with respect to each of the one or more first periods and the standard value.

The detector may, for example, calculate the difference between the acquired value and the standard value. The difference may be, for example, obtained by subtracting the standard value from the acquired value and has the positive or negative sign. Optionally, the difference may also be the difference between an absolute value and a predetermined threshold value.

Note that the detector according to the first embodiment is a detector 123. The detector according to the third embodiment is a detector 222.

### (4-2) Update of Standard Value

The narrowing processor (124, processor 12B) may include an updater.

The updater updates the standard value based on one or more differences detected by the detector (123, 222) for the one or more first periods such that the one or more differences narrow, either at once or gradually, over the one or more second periods.

Note that the updater according to the first embodiment is an updater 1242 and the updater according to the third embodiment is an updater 125.

That is to say, according to the first embodiment, the narrowing processor 124 includes the updater 1242. The updater 1242 updates the standard value based on one or more differences detected by the detector 123 for the one or more first periods such that the one or more differences narrow, either at once or gradually, over the one or more second periods. On the other hand, according to the second embodiment, the processor 12B includes the updater 125. The updater 125 updates the standard value based on one or more differences detected by the detector 222 for the one or more first periods such that the one or more differences narrow, either at once or gradually, over the one or more second periods.

Updating the standard value either at once or gradually in this manner allows the difference to be narrowed either at once or gradually, thereby redressing the improper standard value either at once or gradually.

This allows the activity to be managed appropriately using a target.

### (4-3) Management of Operations Based on Man-Hour

According to the first and third embodiments, the activity may be operations and the target may be man-hour, for example.

The acquirer (121, 221) acquires a man-hour value with respect to each of one or more second periods. The setter (122, 123B) sets a standard man-hour as a standard value for man-hour. The detector (123, 222) acquires the difference between the acquired value and the standard man-hour with respect to each of one or more second periods. The updater (1242, 125) updates the standard man-hour to narrow the difference either at once or gradually over the one or more second periods.

According to the first embodiment, the acquirer 121 acquires the man-hour value with respect to each of the one or more second periods. Note that the man-hour value acquired by the acquirer 121 is preferably a predicted value but may also be an actual value. The setter 122 sets a standard man-hour as a standard value for man-hour. The detector 123 acquires the difference between the acquired value and the standard man-hour with respect to each of the one or more second periods. The updater 1242 updates the standard man-hour to narrow the difference, either at once or gradually, over the one or more second periods.

According to the third embodiment, the observer 221 acquires the man-hour value with respect to each of the one or more second periods. Note that the man-hour value acquired by the observer 221 is an actual value. The setter 123B sets a standard man-hour as a standard value for man-hour. The detector 222 acquires the difference between the acquired value and the standard man-hour with respect to each of the one or more second periods. The updater 125 updates the standard man-hour to narrow the difference, either at once or gradually, over the one or more second periods.

Updating the standard man-hour either at once or gradually in this manner allows the difference to be narrowed either at once or gradually, thereby redressing the improper standard man-hour either at once or gradually.

This allows the operations to be managed appropriately based on the man-hour.

### (4-4) Prediction of Target Value

According to the first and third embodiments, the narrowing processor (124, 12B) further includes a predictor (1243, 122B). The predictor (1243, 122B) predicts a target value and thereby acquires a predicted value. The narrowing processor (124, 12B) may perform narrowing processing to narrow, either at once or gradually, the difference between the standard value and the predicted value acquired by the predictor (1243, 122B).

In the first embodiment, the narrowing processor 124 further includes the predictor 1243.

The predictor 1243 predicts, based on at least two acquired values acquired by the acquirer over the one or more first periods, a value of the target with respect to each of the one or more second periods and thereby acquires a predicted value.

The predictor 1243 predicts the value of the target based on not only the two or more acquired values but also information stored in a memory as well. The memory is usually a memory in the system (such as a memory of a server 2) but may also be memory of an external device. The information stored in the memory may be, but does not have to be, calendar information, weather information, or sales information.

The acquirer (121, 221) acquires the predicted value from the predictor (1243, 122B).

According to the third embodiment, the narrowing processor (processor 12B) further includes a predictor 122B. The predictor 122B acquires a predicted value based on the result of observation made by the observer 221.

Acquiring the predicted value and narrowing the difference between the predicted value and the standard value in this manner contributes to improving the accuracy of management.

### (5) Feature Unique to Third Embodiment

According to the third embodiment, the one or more second periods described above are one or more second periods in the future.

The processor 12B corresponding to the narrowing processor includes a predictor 122B and a creator 124B. The predictor 122B acquires one or more predicted man-hour values (frame by frame or department by department predicted man-hour value PV2) for the one or more second periods in the future by performing a prediction algorithm (man-hour prediction algorithm PA) using a model (man-hour prediction model PM). The model (man-hour prediction model PM) receives, as input, a dataset for prediction DP and outputs the predicted man-hour value (frame by frame or department by department predicted man-hour value PV2). The dataset for prediction DP includes a set of three types of information that are period identification information (time frame identification information TI), period attribute information (day attribute information AI), and quantity information (predicted visitor number value PV1) with respect to each of the one or more second periods in the future. The period identification information (time frame identification information T1) is a piece of information for use to specify a period. The period attribute information (day attribute information AI) is a piece of information about an attribute of the period. The quantity information (predicted visitor number value PV1) is a piece of information about the quantity of operation targets in the period. The setter 123B sets a standard man-hour of the operations.

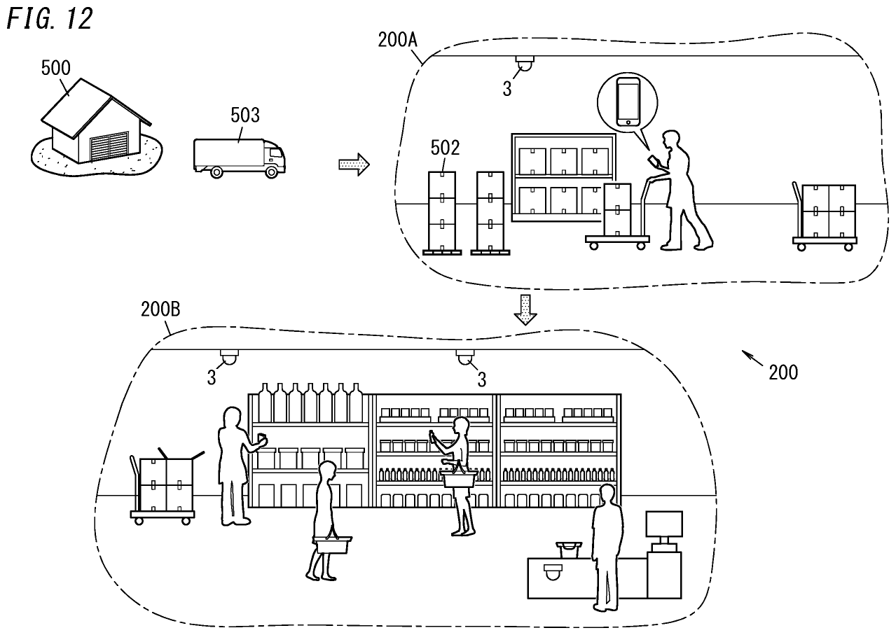

The creator 124B creates an operation plan (refer to FIG. 12B) based, for example, on the standard man-hour set by the setter 123B, the one or more predicted man-hour values (frame by frame or department by department predicted man-hour value PV2) acquired by the predictor 122B, and one or more pieces of personnel information (refer to FIG. 12A) about the one or more persons of the personnel that perform the operation. As used herein, the operation plan (refer to FIG. 12B) is a plan to be put into practice by the one or more persons of the personnel during the one or more second periods in the future.

Acquiring the predicted man-hour value in this manner narrows the difference, thus contributing to improving the accuracy of plan creation.

Note that the feature unique to the first embodiment will be described in detail later.

### (6) First Embodiment

The first embodiment of the present disclosure will now be described. Note that description of matters already mentioned in the previous sections will be either simplified or omitted to avoid redundancies.

### (6-1) Target Management System

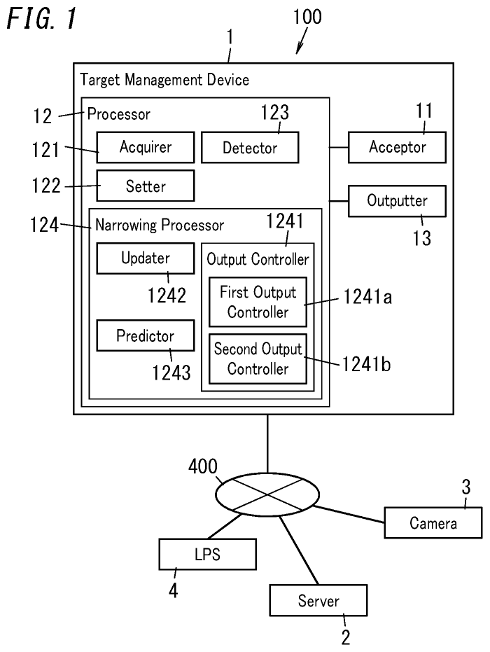

As shown in FIG. 1 a target management system 100 according to the first embodiment of the present disclosure includes a target management device 1, a server 2, a camera 3, and a local positioning system (LPS) 4. The target management device 1 is connected to, and ready to communicate with, each of the server 2, the camera 3, and the LPS 4 via a network 400. The network 400 may be, for example, a local area network (LAN), the Internet, or a communications network.

The target management device 1 manages the activity of an organization using a target. In this embodiment, the organization is a for-profit enterprise. However, this is only an example and should not be construed as limiting. Alternatively, the organization may also be a non-profit organization. The activity may be, for example, operations or business management. The target may be, for example, man-hour or profits.

In this embodiment, the organization is hierarchized into two layers, namely, a field layer and a business management layer. The field layer is a layer to which workers who perform operations in the field belong and is lower in order than the business management layer. The business management layer is a layer to which a manager who makes business management belongs and is higher in order than the field layer.

The activity includes operations assigned to the field layer and business management assigned to the business management layer.

The server 2 stores various types of information. Examples of the various types of information include calendar information, weather information, and sales information.

The camera 3 is installed in the field to shoot targets of operations performed in the field (such as visitors and articles) and the personnel who performs the operations.

The LPS 4 is installed in the field to detect the locations of the personnel (or the articles) in the field.

### (6-2) Target Management Device

As shown in FIG. 1, the target management device 1 includes an acceptor 11, a processor 12, and an outputter 13.

The acceptor 11 accepts various types of information. Examples of the various types of information include the standard value.

The processor 12 performs various types of processing. Examples of the various types of processing include processing to be performed by the acquirer 121, the setter 122, the detector 123, and the narrowing processor 124.

The outputter 13 outputs various types of information. Examples of the various types of information include a value (acquired value) of the target and difference information.

The processor 12 includes the acquirer 121, the setter 122, the detector 123, and the narrowing processor 124.

The acquirer 121 acquires the value of the target. The acquirer 121 may acquire, for example, an actual value of the target with respect to each of the one or more first periods.

Alternatively, the acquirer 121 may also acquire a predicted value of the target with respect to each of one or more second periods that follow the one or more first periods. Specifically, the acquirer 121 acquires the predicted value from a predictor 1243 (to be described later).

The target according to this embodiment includes a first target and a second target. As used herein, the “first target” refers to a target for operations. Examples of the first target include man-hour, the quantity of inventory, and operation efficiency. As used herein, the “second target” refers to target for business management. The second target may be, for example, a business indicator. The business indicator may be, but does not have to be, profits or growth rate. An actual value about the second target may be an actual management value, which is an actual value for a management indicator.

The acquirer 121 acquires, based on the image information provided by the camera 3 and the location information provided by the LPS 4, a first value that is a value of the first target with respect to each of the one or more first periods. Optionally, the acquirer 121 may acquire the first value based on information such as sales information stored in the memory as well.

Note that the acquirer 121 acquires, based on at least the value of the first target, a second value as value of the second target with respect to each of the one or more first periods. Optionally, the acquirer 121 may acquire the second value based on information such as the sales information stored in the memory as well.

The setter 122 sets a standard value for the target. For example, the setter 122 may set a standard man-hour as a standard value for man-hour.

The setter 122 may set, for example, a first standard value. As used herein, the “first standard value” refers to a standard value for the first target.

The setter 122 sets the first standard value with respect to each of two or more departments, for example.

The setter 122 sets a second standard value based on at least the first standard value. As used herein, the “second standard value” refers to a standard value for the second target

The setter 122 sets the second standard value based on, for example, information such as sales information stored in either a memory in the system or a memory of an external device as well.

The detector 123 detects a second difference with respect to each of the one or more first periods. As used herein, the “second difference” refers to the difference between a second acquired value that is the second value acquired by the acquirer 121 and the second standard value.

The detector 123 detects the difference between an acquired value that is the value acquired by the acquirer 121 and the standard value.

The detector 123 detects the difference between the acquired value that is the value acquired by the acquirer 121 and the standard value with respect to each of the one or more first periods, for example.

The detector 123 detects the first difference between a first acquired value that is the first value acquired by the acquirer 121 and the first standard value with respect to each of the one or more first periods.

### (6-3) Narrowing Processing

The narrowing processor 124 performs the narrowing processing as described above.

As shown in FIG. 1, the narrowing processor 124 includes, for example, the output controller 1241, the updater 1242, and the predictor 1243.

The narrowing processor 124 may perform first narrowing processing based on, for example, one or more first differences detected by the detector 123 for the one or more first periods. As used herein, the “first narrowing processing” refers to processing to narrow, either at once or gradually, the first difference between the first value acquired by the acquirer 121 in one or more second periods following the one or more first periods and the first standard value.

This allows the field layer to manage the operations appropriately using the first target (such as man-hour).

In addition, the narrowing processor 124 may also perform second narrowing processing based on, for example, one or more second differences detected by the detector 123 for the one or more first periods. As used herein, the “second narrowing processing” refers to processing to narrow, either at once or gradually, the second difference between the second value acquired by the acquirer 121 in one or more second periods following the one or more first periods and the second standard value.

This allows the business management layer to manage the business management appropriately using the second target (such as profits).

The narrowing processor 124 may further perform third narrowing processing. As used herein, the “third narrowing processing” refers to processing to narrow, either at once or gradually, the one or more first differences detected by the detector 123 for the one or more second periods, based on one or more second differences detected by the detector 123 for the one or more first periods.

Optionally, the third narrowing processing may be the processing of outputting, for example, when the second difference exceeds a threshold value, the one or more first differences for the one or more first periods in a recognizable form. In that case, the narrowing processor 124 may have not only the one or more first differences for the one or more first periods but also the one or more second differences for the one or more second periods output in the recognizable form.

This reduces the chances of the second difference widening by making the business management layer perform, as the second difference widens (e.g., as the profits decrease), the processing of narrowing the first difference (e.g., outputting the first difference in a recognizable form) that constitutes a main cause of widening of the second difference.

The organization according to this embodiment includes two or more departments belonging to the field layer. The two or more departments belonging to the field layer may be, for example, a physical distribution department and a selling department.

In this case, the acquirer 121 acquires the first value and the second value with respect to each of multiple combinations of the two or more departments, the one or more first periods, and the one or more second periods. The setter 122 sets the first standard value and the second standard value with respect to each of the two or more departments. The detector 123 detects the first difference and the second difference with respect to each of multiple combinations of the two or more departments, the one or more first periods, and the one or more second periods. The narrowing processor 124 performs the first narrowing processing and the second narrowing processing with respect to each of the two or more departments.

The narrowing processor 124 may also perform, for example, the third narrowing processing with respect to each of the two or more departments.

For example, if the second difference exceeds a threshold value in a certain department, then the narrowing processor 124 has two or more first differences, corresponding to that department, output in a recognizable form. In addition, the narrowing processor 124 may have two or more second differences output in a recognizable form as well.

This allows each of two or more departments that are separately performing the operations to cooperate with the business management.

### (6-3-1) Output Control

As shown in FIG. 1, the output controller 1241 includes a first output controller 1241a and a second output controller 1241b.

The first output controller 1241a has an acquired value that is the value acquired by the acquirer 121 output. The second output controller 1241b has a result of comparison between the acquired value and the standard value output in a recognizable form.

Note that the output controller 1241 may have a piece of information, falling within the range to be specified by one or more types of identification information selected from the group consisting of the personnel identification information, the hierarchical layer identification information, the department identification information, and the period identification information, output.

Specifically, when the acceptor 11 accepts the operation of selecting one or more types of identification information, the output controller 1241 has a piece of information, falling within the range specified by the one or more types of identification information thus accepted, output. For example, if the personnel identification information and the period identification information are selected, then information falling within the range associated with the personnel identification information and the period identification information is output.

In addition, the acceptor 11 may accept the value of the identification information with respect to each of the one or more types of identification information thus accepted and the output controller 1241 may have a piece of information, corresponding to the one or more values thus accepted, output out of the pieces of information falling within the range specified by the one or more types of identification information. For example, if the respective values of the personnel identification information and the period identification information are accepted, then information such as work schedule information of the personnel represented by the value of the personnel identification information in the period represented by the value of the period identification information is output.

### (6-3-2) Update of Standard Value

The updater 1242 updates, based on one or more differences detected by the detector 123 for the one or more first periods, the standard value to narrow the one or more differences, either at once or gradually, over the one or more second periods.

The updater 1242 may update the standard man-hour set by the setter 122 to bring, for example, the value (such as an actual value) of the target acquired by the acquirer 121 closer to the standard man-hour.

Specifically, the updater 1242 changes (e.g., causes an increment), to a predetermined amount every time in either an increasing direction or a decreasing direction (e.g., in the increasing direction), the standard value set by the setter 122 for the target (i.e., the standard value stored in the memory) to determine whether the difference widens or narrows according to this change.

If the difference detected by the detector 123 widens according to this change, then the updater 1242 inverts the direction of change and performs the same operation as the one described above. That is to say, the updater 1242 changes (i.e., causes a decrement), to a predetermined amount every time in the opposite direction from the one described above (i.e., in the decreasing direction), the standard value for the target to determine whether the difference widens or narrows according to this change.

If the difference narrows according to this change, the updater 1242 will perform the same operation continuously until just before the difference starts increasing (i.e., until the difference reaches a local minimum value). As a result, the standard value for the target is updated into a value that makes the difference a local minimum.

Updating the standard value in this manner allows the difference between the actual value and the standard value to be narrowed either at once or gradually.

### (6-3-3) Prediction

### (6-3-3a) Acquisition of Predicted Value

The predictor 1243 predicts, at least based on two or more acquired values that are the values acquired by the acquirer 121 in the one or more first periods, a value of the target and acquires a predicted value with respect to each of the one or more second periods.

The predictor 1243 predicts the value of the target and acquires the predicted value based on, for example, the information stored in the memory as well.

(6-3-3b) Update of Predicted Value

The updater 1242 updates the predicted value acquired by the predictor 1243 to narrow the difference detected by the detector 123.

The updater 1242 may update the predicted value to bring, for example, the actual value acquired by the acquirer 121 closer to the standard value.

Specifically, the updater 1242 changes, to a predetermined amount every time in either an increasing direction or a decreasing direction (e.g., in the increasing direction), the predicted value acquired by the predictor 1243 (e.g., the predicted value stored in the memory) to determine whether the difference widens or narrows according to this change.

If the difference widens according to this change, then the updater 1242 inverts the direction of change and performs the same operation as the one described above. That is to say, the updater 1242 changes, to a predetermined amount every time in the opposite direction (i.e., in the decreasing direction) from the one described above, the predicted value to determine whether the difference widens or narrows according to this change.

If the difference narrows according to this change, the updater 1242 will perform the same operation continuously until the difference starts increasing (i.e., until the difference reaches a local minimum value). As a result, the predicted value is updated into a value that makes the difference a local minimum.

Updating the predicted value in this manner allows the difference between the actual value and the standard value to narrow either at once or gradually.

Consequently, this contributes to narrowing the difference and eventually optimizing the operation plan.

Note that the updater 1242 preferably updates both the predicted value and the standard value. That is to say, the updater 1242 updates the predicted value to make the difference a local minimum value, for example, and then updates the standard value to make the difference a local minimum value (second local minimum value) smaller than the former local minimum value (first local minimum value).

Alternatively, the predicted value and the standard value may be updated in reverse order from the one described above. That is to say, the updater 1242 may update the standard value to make the difference a local minimum value and then update the predicted value to make the difference a local minimum value (second local minimum value) smaller than the former local minimum value (first local minimum value).

Optionally, the updater 1242 may update the predicted value and the standard value alternately and repeatedly. This contributes to further narrowing the difference.

Alternatively, the updater 1242 may update only the predicted value without updating the standard value. Still alternatively, the updater 1242 may update only the standard value without updating the predicted value. The difference may be narrowed in any case.

### (6-3-4) Update of Other Parameters

For example, the processor 12 may create an operation plan based on the information about the target (such as the standard value) and the updater 1242 may change the operation plan to narrow, either at once or gradually, the difference between the acquired value for the target and the standard value.

Alternatively, the updater 1242 may update a series of operation process steps that form the operation to narrow, either at once or gradually, the difference between the acquired value for the target and the standard value.

### (6-3-5) Operation of Target Management Device

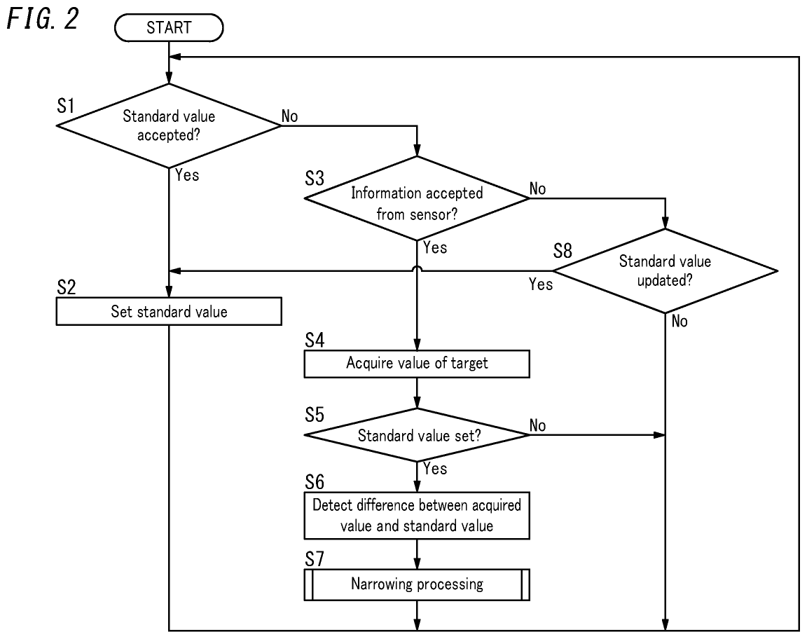

The target management device 1 performs the processing following the procedure of the flowchart shown in FIG. 2. Note that the processing shown in FIG. 2 is started when the target management device 1 is powered ON and ended when the target management device 1 is powered OFF.

The processor 12 determines whether the acceptor 11 has accepted a standard value for a target (in Step S1). If a decision is made in Step S1 that the acceptor 11 have accepted the standard value for the target (if the answer is YES in Step S1), the process proceeds to Step S2. On the other hand, if a decision is made in Step S1 that the no standard value have been accepted (if the answer is NO in Step S1), then the process proceeds to Step S3.

The setter 122 sets the value accepted in Step S1 as the standard value for the target (in Step S2). The standard value thus set is stored in the memory. Thereafter, the process goes back to Step S1.

The processor 12 determines whether any information has been accepted from the sensor (such as the camera 3) (in Step S3). If a decision is made in Step S3 that no information have been accepted from the sensor (if the answer is NO in Step S3), the process proceeds to Step S8.

The acquirer 121 acquires, based on the information accepted in Step S3, a value for the target (in Step S4). Note that the value acquired in this process step for the target is at least one of a predicted value or an actual value. In this embodiment, the predicted value and the actual value are both acquired. The value(s) thus acquired for the target is/are stored in the memory.

The processor 12 determines whether any standard value has been set yet (in Step S5). If a decision is made in Step S5 that some standard value have already been set (if the answer is YES in Step S5), the process proceeds to Step S6. On the other hand, if a decision is made in Step S1 that no standard value have been set yet (if the answer is NO in Step S5), then the process proceeds to Step S8.

The detector 123 detects the difference between the acquired value acquired in Step S2 and the standard value set in Step S4 (in Step S6).

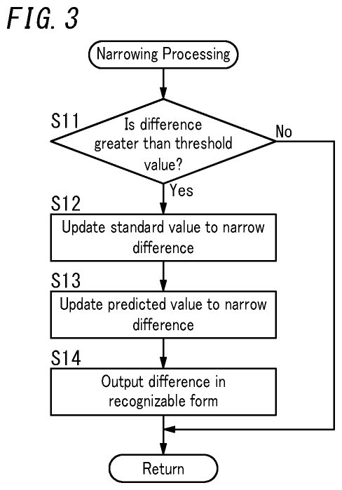

The narrowing processor 124 performs narrowing processing to narrow the difference detected in Step S6 (in Step S7). Note that the narrowing processing will be described later with reference to the flowchart shown in FIG. 3. Thereafter, the process returns to Step S1.

The processor 12 determines whether the standard value has been updated (in Step S8). Note that if the updater 1242 performs Step S12 (to be described later), then the processor 12 decides that the standard value have been updated. If a decision is made in Step S8 that the standard value have been updated (if the answer is YES in Step S8), the process goes back to Step S2. On the other hand, if a decision is made in Step S8 that the standard value have not been updated yet (if the answer is NO in Step S8), then the process goes back to Step S1.

The narrowing processing of Step S7 may be performed, for example, following the procedure of the flowchart shown in FIG. 3.

The processor 12 determines whether the difference detected in Step S6 is greater than a predetermined threshold value (in Step S11). If a decision is made in Step S11 that the difference be greater than the threshold value (if the answer is YES in Step S11), the process proceeds to Step S12. On the other hand, if a decision is made in Step S11 that the difference be equal to or less than the threshold value (if the answer is NO in Step S11), then the process returns to the higher-order flowchart shown in FIG. 2.

The updater 1242 updates the standard value in the memory to narrow the difference detected in Step S6 (in Step S12). In addition, the updater 1242 also updates the predicted value in the memory to narrow the difference detected in Step S6 (in Step S13). That is to say, the standard value and the predicted value are each updated to narrow the difference.

Next, the output controller 1241 has the difference detected in Step S6 output in a recognizable form (in Step S14). Thereafter, the process returns to the higher-order flowchart shown in FIG. 2.

Note that although not shown in FIG. 3, the narrowing processing may further include changing the plan and changing the series of process steps as described above.

### (6-4) Variation of Target Management System

Optionally, the target management system 100 may further include a generator (not shown) for generating a model to be used by the predictor 1243 for prediction.

The generator generates a model by performing a machine learning algorithm using, as input, a set including various types of information (such as image information and location information) provided by the sensor (such as the camera 3 and the LPS 4) and the actual value of the target (such as actual value of man-hour for use as training data).

Note that the generator according to the third embodiment is a generator 121B. The machine learning algorithm according to the third embodiment is a learning algorithm LA. Furthermore, the model according to the third embodiment is a man-hour prediction model PM.

### (7) Second Embodiment

### (7-1) Shelf Stocking Management System

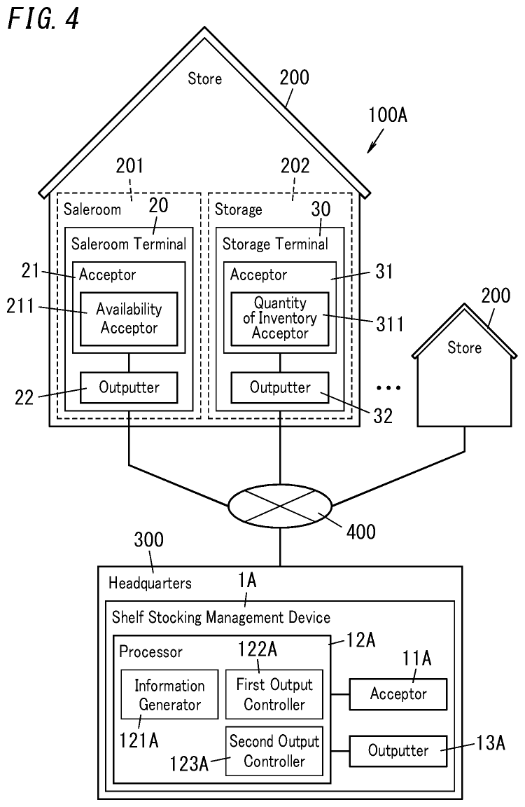

A shelf stocking management system 100A according to a second embodiment of the present disclosure includes a shelf stocking management device 1A, one or more saleroom terminals 20, and one or more storage terminals 30 as shown in FIG. 4. The shelf stocking management device 1A is connected to, and ready to communicate with, each of the one or more saleroom terminals 20 and the one or more storage terminals 30 via a network 400 such as a wireless or wired LAN, the Internet, or a telephone network.

The shelf stocking management device 1A according to this embodiment may be, for example, a server and includes a processor, a memory, a communications module, and other components (none of which are shown in FIG. 4). The shelf stocking management device 1A usually includes an input device and an output device (neither of which is shown in FIG. 4). Examples of the input device include a keyboard and a touchscreen panel. Examples of the output device include a display, a loudspeaker, and a printer. The shelf stocking management device 1A may further include a shooting device (not shown, either). Examples of the shooting device include a camera and a scanner.

In the shelf stocking management device 1A, various types of information and programs are stored in the memory, and the processor performs various types of processing to be performed by the processor 12A (to be described later) in accordance with the various types of information and programs in the memory. Note that such a combination of the processor and the memory may be called a “computer.” The same statement applies to the processor 12 of the target management device 1 according to the first embodiment and the processor 12B of the plan creator 1B and the processor 22B of the difference detector 2B according to the third embodiment.

The saleroom terminals 20 and the storage terminals 30 are mobile communications devices. Each of the mobile communications devices may be, for example, a smartphone or a tablet computer and includes a processor, a memory, a communications module, an input device, an output device, a shooting device, and other components. In each of the saleroom terminals 20 and the storage terminals 30, various types of information and programs are also stored in the memory and the processor may also perform various types of processing.

The communications module included in each of the shelf stocking management device 1A, the saleroom terminals 20, and the storage terminals 30 enables establishing communication via the network 400 (i.e., transmission and reception of various types of information between the shelf stocking management device 1A, the saleroom terminals 20, and the storage terminals 30).

The shelf stocking management system 100A according to this embodiment is used by a retail operator such as a supermarket or a home improvement store. The retail operator according to this embodiment includes headquarters 300 and one or more stores 200. Each of the stores 200 has a saleroom 201 and storage 202. In the saleroom 201, one or more showcases (not shown) to display products are arranged. The storage 202 is divided into a plurality of compartments (not shown), in each of which one or more cart racks (not shown, either) to keep products in stock movably are stationed.

Note that in this embodiment, the store 200 is a single building, in which the saleroom 201 and the storage 202 are provided. However, this is only an example and should not be construed as limiting. Alternatively, the saleroom 201 and the storage 202 may be present in two different buildings, respectively. Optionally, the storage 202 may also be shared by multiple stores 200.

### (7-2) Shelf Stocking Management Device

The shelf stocking management device 1A according to the second embodiment of the present disclosure includes a processor 12A, an acceptor 11A, and an outputter 13A as shown in FIG. 4. The processor 12A includes an information generator 121A, a first output controller 122A, and a second output controller 123A.

In this embodiment, the information generator 121A is included in the shelf stocking management device 1A. However, this is only an example and should not be construed as limiting. Alternatively, the information generator 121A may be included in any of the saleroom terminals 20 or the storage terminals 30 and may be provided anywhere without limitation.

The processor 12A performs various types of processing. As used herein, the various types of processing refer to, for example, the processing to be performed by the information generator 121A, the first output controller 122A, and the second output controller 123A as will be described later. In addition, the processor 12A also compares the shelf stocking related information with the evaluation index as will be described later and further makes various decisions to be described later with reference to the flowcharts. Other types of processing will be described later as needed.

The acceptor 11A accepts various types of information. Examples of the various types of information include availability information, quantity of inventory information, and various instructions (each of which will be described later).

The acceptor 11A usually accepts information that has been received via a communications module. However, this is only an example and should not be construed as limiting. Alternatively, the acceptor 11A may also accept various other pieces of information inside the shelf stocking management device 1A without limitation. For example, the acceptor 11A may also accept information that has been entered via an input device, information that has been read by a reading device (such as a scanner), and information that has been read out from a storage medium such as a memory or a disc.

The acceptor 11A accepts the availability information that the acceptor 11A has received from one of the saleroom terminals 20 via the communications module. As used herein, the “availability information” refers to a piece of information indicating whether a product in question is unavailable in the saleroom 201 of the store 200. The availability information includes, for example, a store identifier to identify the store 200, a product identifier to identify the product in question, and a flag indicating whether the product is unavailable.

Nevertheless, if the number of stores is only one (i.e., if the retail operator has only one store 200), then the availability information does not have to have the store identifier. Also, if the number of products dealt by the store 200 is only one, then the availability information does not have to have the product identifier. The same statement applies to the quantity of inventory information (to be described later) as well.

In addition, the acceptor 11A also accepts the quantity of inventory information that the acceptor 11A has received from any of the storage terminals 30 via the communications module. Alternatively, at least one of the availability information or the quantity of inventory information may be accepted via the input device included in the shelf stocking management device 1A.

The outputter 13A outputs various types of information. Examples of the various types of information include the shelf stocking related information, a first unavailable product list, and a second unavailable product list (each of which will be described later).

The outputter 13A usually outputs information to a monitor. The monitor to which the information is output is usually a monitor included in the shelf stocking management device 1A. However, this is only an example and should not be construed as limiting. Alternatively, the information may also be output to an external monitor (not shown) provided in the headquarters 300 or a monitor provided at either any of the saleroom terminal 20 or any of the storage terminals whichever is appropriate.

Note that the information may be, for example, emitted as a sound from a loudspeaker, printed out by a printer, stored in a storage medium, or transmitted to an external device, whichever is appropriate. The same statement applies to the outputter (22, 32) of each of the saleroom terminals 20 and the storage terminals 30 as well.

### (7-5) Shelf Stocking Related Information

The information generator 121A that forms part of the processor 12A generates shelf stocking related information. As used herein, the shelf stocking related information refers to a piece of information related to shelf stocking to be performed in the store 200.

As used herein, the “shelf stocking” refers to carrying in and displaying products into the saleroom 201. The products to be carried in may be either products that have been newly shipped from supplier such as a factory or a wholesaler or products that were shipped in the past and have been stored in the storage 202, whichever is appropriate.

In this embodiment, the newly shipped products are supposed to be usually once loaded into the storage 202, and then carried in the saleroom 201 and displayed on the shelves as needed. Nevertheless, some products may be directly carried in the saleroom 201 without being loaded into the storage 202 once.

Also, the products stored in the storage 202 of the store 200 are supposed to be, for example, picked by a small carry-in cart and then carried in the saleroom 201 and displayed there. Alternatively, the products stored in the storage 202 may also be directly carried in the saleroom 201 while being put on the cart rack and then displayed there. The products carried in the saleroom 201 which have not been displayed are supposed to be either loaded into the storage 202 again or returned to the supplier.

Examples of the shelf stocking related information include quality of inventory information (representing days of inventory on hand), number of unavailable products information (first number of unavailable products information, second number of unavailable products information), operation efficiency information, occupancy rate information, progress information, quantity of returned products information, and slow-moving inventory information.

As used herein, the “quantity of inventory information” refers to a piece of information about the number or quantity of products stored in the storage 202 of the store 200.

The quantity of inventory information may be, for example, either a piece of information about the total quantity of all products or a piece of information about product-by-product or group-by-group quantities, whichever is appropriate. The quantity of inventory information may include, for example, a store identifier to identify the store 200, a product identifier to identify a product in question, and the quantity of inventory.

The quantity of inventory information according to this embodiment represents the days of inventory on hand (DOH). As used herein, the days of inventory on hand is a piece of information indicating how many days it takes to sell through the inventory stored (or actually present) in the storage 202.

Alternatively, the quantity of inventory information may also be the quantity of physical inventory. As used herein, the “quantity of physical inventory” is a piece of information indicating the quantity of products stored in the storage 202 (e.g., 10 products, 1 box, or 3 kg). Note that the days of inventory on hand is a value obtained by dividing the quantity of physical inventory by the quantity of products sold per day.

Alternatively, the quantity of inventory information may also be a piece of information about the total quantity of all products or a piece of information about product-by-product or type-by-typequantities. Optionally, the types of products may also be hierarchized into groups, categories, or subcategories, for example.

As used herein, the “number of unavailable products information” refers to a piece of information about the number of unavailable products. As used herein, the “unavailable products” refer to products that are unavailable from the saleroom 201 of the store 200. As used herein, to “be unavailable” means that a product in question is missing from the saleroom 201. The number of unavailable products information includes first number of unavailable products information and second number of unavailable products information.

As used herein, the “first number of unavailable products information” refers to a piece of information about a first type of unavailable products. As used herein, the “first type of unavailable products” refer to products missing from the saleroom 201 which are still in stock in the storage 202 and may be herein referred to as “temporarily unavailable in-stock products.” As used herein, the “second number of unavailable products information” refers to a piece of information about a second type of unavailable products. As used herein, the “second type of unavailable products” refer to products missing from the saleroom 201 which are out of stock in the storage 202 and may be herein referred to as “unavailable out-of-stock products.”

The first number of unavailable products information is linked to a first unavailable product list (not shown but to be described later). As used herein, the “first unavailable product list” refers to a list of the first type of unavailable product(s). The first unavailable product list will be described in detail later.

Optionally, the first unavailable product list may be associated with shelf stocking recommendation information. As used herein, the “shelf stocking recommendation information” refers to a piece of information giving recommendation to make stocking the saleroom 201 with products stored in the storage 202. The shelf stocking recommendation information may be, for example, a character string (message) that says, for example, “please stock the shelves with products on the list” but may also be a mark (such as an icon) representing shelf stocking.

The second number of unavailable products information is linked to a second unavailable product list (not shown). As used herein, the “second unavailable product list” refers to a list of the second type of unavailable product(s). The second unavailable product list will be described in detail later.

Optionally, the second unavailable product list may be associated with placement of order recommendation information. As used herein, the “placement of order recommendation information” refers to a piece of information giving recommendation to place an order with the supplier of the products. The placement of order recommendation information may be, for example, a character string (message) that says, for example, “please place an order for products on the list” but may also be a mark (such as an icon) representing a placement of order.

As used herein, the “operation efficiency information” refers to a piece of information about the efficiency of shelf stocking operation. As used herein, the “shelf stocking operation” refers to the operation of stocking the shelves in the saleroom 201 of the store 200 with products stored in the storage 202. The operation efficiency information may be, for example, a piece of information indicating how many products a person has managed to stock the shelves with per hour but may also be a piece of information indicating how much time it has taken for a person to stock the shelf with a single product.

The operation efficiency information may also be, for example, a piece of information indicating a rate of progress. As used herein, the “rate of progress” refers to a piece of information indicating how the operation has progressed per unit time (e.g., one hour). Specifically, the rate of progress is represented as the workload by a single worker per hour (e.g., the number of products processed by the worker per hour). Optionally, the operation efficiency information may be generated based on progress information (to be described later).

As used herein, the “occupancy rate information” refers to a piece of information about the occupancy rate. As used herein, the “occupancy rate” refers to a piece of information indicating the degree to which the storage 202 is occupied by the products kept in stock in the storage 202 of the store 200 (hereinafter referred to as “in-stock products”).

The occupancy rate as used herein may be either the occupancy rate of the products themselves to the storage 202 or the occupancy rate of storage members that keep the products in stock to the storage 202, whichever is appropriate. The storage member is preferably the cart rack as described above but may also be a small carry-in cart or a not-easily-movable member such as a pallet or a stock shelf.

The occupancy rate according to this embodiment is the occupancy rate of a cart rack to the storage 202 (such as a back room (BR)) (hereinafter referred to as a “BR cart rack occupancy rate”). As described above, the storage 202 is divided into multiple compartments, in each of which one or more cart racks are stationed. The BR cart rack occupancy rate is a value calculated by dividing the number of cart racks loaded with products (registered cart racks) by the total number of compartments.

In general, the occupancy rate is calculated by the equation: occupancy rate={number of storage members (registered storage members)}/total number of compartments. Nevertheless, in this case, the denominator does not have to be the total number of compartments but may also be anything else as long as the denominator is a numerical value representing the extent of the storage 202. For example, the denominator may be the area of the storage 202 or the total number of storage members in the storage 202, whichever is appropriate.

As used herein, the “progress information” refers to a piece of information indicating the degree of progress of the shelf stocking operation with respect to unavailable products. The progress information includes number of times of execution information. As used herein, the “number of times of execution information” refers to a piece of information indicating the number of times the shelf stocking operation has been executed.

The shelf stocking operation includes one or more types of operations (i.e., one or more item of operation) selected from the group consisting of a request operation, a picking operation, a display operation, a return operation, and a simultaneous stocking operation to be performed before the store is opened (hereinafter simply referred to as a “simultaneous stocking operation”).

As used herein, the “request operation” refers to the operation of requesting to do shelf stocking for unavailable products. The “picking operation” as used herein refers to the operation of picking, in response to the shelf stocking request, products corresponding to the unavailable products in the storage 202. The “display operation” as used herein refers to the operation of displaying, in the saleroom 201, the products that have been picked through the picking operation. The “return operation” as used herein refers to the operation of returning, to the storage 202, the products picked through the picking operation which have not been displayed in the saleroom 201. The “simultaneous stocking operation” as used herein refers to the operation of simultaneous stocking involving neither the request operation nor the picking operation.

The progress information includes number of times of execution information about the number of times each of the one or more types of operations has been executed. The progress information may also be, for example, the ratio of the number of times the picking operation and/or the display operation has been executed to the number of times the request operation has been executed.

As used herein, the “quantity of returned products information” refers to a piece of information about the quantity of returned products. As used herein, the “quantity of returned products” refers to the quantity of products carried in the saleroom 201 which have been returned to the source without being displayed in the saleroom 201 (hereinafter referred to as “returned products”). Specifically, the quantity of returned products may be the quantity of products picked through the picking operation which have been returned to the storage 202 without being displayed in the storage 202 through the display operation.

Note that the products as used herein include two types, namely, standard products and merchandizing (MD) products. As used herein, the “standard products” refer to products which are always in stock in the store 200 and which are the object of automatic placement of order (to be described later). The standard products that have been shipped from the supplier are usually loaded into the storage 202 and unloaded from the storage 202 to the saleroom 201 for the purpose of shelf stocking, every time the standard products become unavailable in the saleroom 201. Nevertheless, some of the standard products that have been shipped may be directly carried in the saleroom 201 without being loaded into the storage 202 once.

As used herein, the MD products refer to products which are for sale for only a limited period or in limited quantities and which are not the object of automatic placement of order. The MD products shipped from the supplier are usually all loaded into the storage 202 and carried in the saleroom 201 while being still put on a cart rack. Optionally, the standard products and the MD products do not have to be distinguished from each other.

As used herein, the “quantity of slow-moving inventory information” refers to the quantity of slow-moving inventory. As used herein, the “quantity of slow-moving inventory” refers to the number of in-stock products which have been stored in the storage 202 for a (storage) period longer than a threshold value (e.g., 10 days or 1 month).

The shelf stocking related information according to this embodiment includes the quality of inventory information, the number of unavailable products information, the operation efficiency information, the occupancy rate information, the progress information, the slow-moving inventory information, and the quantity of returned products information. However, this is only an example and should not be construed as limiting. Alternatively, the shelf stocking related information may include at least one type of information selected from the group consisting of the quality of inventory information, the number of unavailable products information, the operation efficiency information, the occupancy rate information, the progress information, the slow-moving inventory information, and the quantity of returned products information.

### (7-4) Generation of Shelf Stocking Related Information

The information generator 121A generates the first number of unavailable products information and the second number of unavailable products information based on, for example, the availability information accepted by an availability acceptor 211 and the quantity of inventory information accepted by a quantity of inventory acceptor 311.

In addition, the information generator 121A also generates the operation efficiency information, the occupancy rate information, the progress information, the slow-moving inventory information, and the quantity of returned products information based on the first number of unavailable products information and the second number of unavailable products information that have been generated as described above and the various types of information stored in the memory.

Examples of the various types of information stored in the memory include the first number of unavailable products information and the second number of unavailable products information that were generated in the past. As used herein, the first number of unavailable products information and the second number of unavailable products information that were generated in the past include the first number of unavailable products information and the second number of unavailable products information that were generated during the last inventory check and the first number of unavailable products information and the second number of unavailable products information that were generated during the second last inventory check. Optionally, pieces of first number of unavailable products information and second number of unavailable products information for more than three inventory checks may be stored in the memory.

In addition, the memory further stores execution history information about the history of the various types of operations that have been executed as described above. The execution history information herein refers to a set of one or more pieces of execution information. Examples of the execution information include pieces of information indicating the type of the operation, the person who executed the operation, the time when the operation was executed, and number of times the operation has been executed.

Every time the operation is executed by a salesclerk, the execution information is entered into either the saleroom terminal 20 or the storage terminal 30. In either the saleroom terminal 20 or the storage terminal 30, the acceptor (21 or 31) accepts the execution information entered and the outputter (22 or 32) transmits the execution information to the shelf stocking management device 1A. In the shelf stocking management device 1A, the acceptor 11A receives the execution information and the processor 12A stores the execution information in the memory. As a result, the execution history information in the memory is updated.

The information generator 121A generates, by a predetermined algorithm, the operation efficiency information, the progress information, the slow-moving inventory information, and the quantity of returned products information based on the first number of unavailable products information and the second number of unavailable products information that have been generated and the execution history information stored in the memory.

In addition, multiple pieces of cart rack information are further stored in the memory in association with cart rack identifiers for use to identify respective cart racks from each other. As used herein, the “cart rack information” refers to a piece of information about the cart racks stationed in the storage 202. The cart rack information about each cart rack includes a compartment identifier for use to identify the compartment where the cart rack is stationed and burden information indicating whether the cart rack is loaded with any burden and the type (such as the group, category, or name of the product) of the burden.

Every time products are loaded into, or unloaded from, a cart rack, the salesclerk enters the cart rack information along with the cart rack identifier. Then, in either the saleroom terminal 20 or the storage terminal 30, the acceptor (21 or 31) accepts the cart rack information and the outputter (22 or 32) transmits the cart rack information to the shelf stocking management device 1A. In the shelf stocking management device 1A, the acceptor 11A receives the cart rack information along with the cart rack identifier and the processor 12A updates the cart rack information, associated with the cart rack identifier thus received, in the memory into the cart rack information received.

The information generator 121A generates, by a predetermined algorithm, the occupancy rate information based on the first number of unavailable products information and the second number of unavailable products information thus generated and multiple pieces of cart rack information stored in the memory.

### (7-5) Output Control of Shelf Stocking Related Information

The first output controller 122A has the shelf stocking related information, generated by the information generator 121A, output. The first output controller 122A according to this embodiment usually makes the outputter 13A of the shelf stocking management device 1A output the shelf stocking related information generated by the information generator 121A.

Alternatively, the first output controller 122A may also make the outputter (22 or 32) of either the saleroom terminal 20 or the storage terminal 30 output the shelf stocking related information.

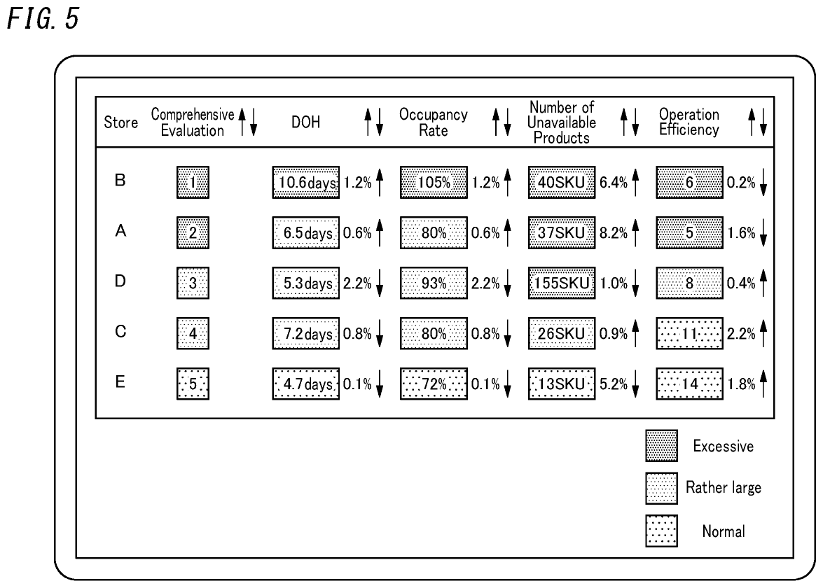

The first output controller 122A according to this embodiment has multiple pieces of shelf stocking related information, concerning a plurality of stores 200, output such that the multiple pieces of shelf stocking related information may be compared with each other (hereinafter referred to as “in a comparable form”). As used herein, outputting the multiple pieces of shelf stocking related information in a comparable form means, for example, displaying the multiple pieces of shelf stocking related information on the same screen as shown in FIG. 5 (as will be described later).

Alternatively, outputting the multiple pieces of shelf stocking related information in a comparable form may also be, for example, sequentially outputting the multiple pieces of shelf stocking related information, concerning the multiple stores 200, at predetermined time intervals (of 5 seconds, for example).

Optionally, the first output controller 122A may have the first unavailable product list output in association with the first number of unavailable products information. The first unavailable product list is a list of the first type of unavailable products corresponding to the first number of unavailable products information. With the first unavailable product list, various types of information such as the name of the product, the group, and the shelf stocking number (i.e., the number of products to stock the shelves in the saleroom 201) are registered with respect to each of the one or more unavailable products in stock in the storage 202 (i.e., the first type of unavailable products). Optionally, the first output controller 122A may display such a first unavailable product list along with the shelf stocking recommendation information described above.

This makes it easier to perform the operation of requesting shelf stocking for temporarily unavailable in-stock products.

Optionally, the first output controller 122A may also have the second unavailable product list output in association with the second number of unavailable products information. The second unavailable product list is a list of the second type of unavailable products corresponding to the second number of unavailable products information. With the second unavailable product list, one or more sets of information, each consisting of the name of the product and the quantity to place an order for (with the supplier), is registered with respect to each of the one or more unavailable products out of stock in the storage 202 (i.e., the second type of unavailable products). Optionally, the first output controller 122A may display such a second unavailable product list along with the placement of order recommendation information described above.

This makes it easier to perform the operation of placing an order for unavailable out-of-stock products.

Note that in response to the entry of the availability information and the quantity of inventory information, for example, the information generator 121A may generate the first number of unavailable products information and the second number of unavailable products information, and the first output controller 122A may have the first number of unavailable products information and second number of unavailable products information thus generated held in an internal memory and have the first number of unavailable products information and the second number of unavailable products information thus held output on a regular or irregular basis.

As used herein, to output the information on a regular basis may refer to, for example, outputting the information at predetermined intervals (e.g., once every 10 minutes). Meanwhile, to output the information on an irregular basis may refer to, for example, outputting either the first number of unavailable products information or the second number of unavailable products information in response to generation of the first or second number of unavailable products information.

This enables outputting, in real time, information about the number of temporarily unavailable in-stock products and information about the number of unavailable out-of-stock products.

### (7-6) Output Control of Result of Comparison Between Shelf Stocking Related Information and Evaluation Index

The second output controller 123A has the result of comparison between the shelf stocking related information and the evaluation index output in a recognizable form.

As used herein, the evaluation index refers to a piece of information for use as a criterion for making evaluation about shelf stocking. Examples of objects of evaluation include the quantity of inventory, the quantity of unavailable products, the operation efficiency, the occupancy rate, and the progress. In this embodiment, the second output controller 123A outputs the results of comparison between the shelf stocking related information about these parameters and the evaluation index in a recognizable form, thereby making it easier to make evaluation about the shelf stocking.

The evaluation index includes a reference value set with respect to the shelf stocking related information. The reference value may be, for example, a target value or a threshold value. Optionally, the evaluation index may be made up of a plurality of reference values including a first reference value, a second reference value, and so on (where either first reference value<second reference value<and so on or first reference value>second reference value>and so on is satisfied).

Outputting the result of comparison in a recognizable form means, in this embodiment, changing, according to the result of comparison, a parameter of the shelf stocking related information displayed. In this embodiment, the parameter of the shelf stocking related information to change is its color. However, this is only an example and should not be construed as limiting. Alternatively, the shade, luminance, size, or font of the shelf stocking related information displayed may be changed instead.

Specifically, if the shelf stocking related information is operation efficiency information, then the evaluation index is a target value of the operation efficiency. The second output controller 123A compares the operation efficiency information with the target value. If the result of comparison indicates “operation efficiency≥target value,” the second output controller 123A displays the operation efficiency information in blue. If the result of comparison indicates “operation efficiency<target value,” the second output controller 123A displays the operation efficiency information in red. This enables evaluating the operation efficiency of the shelf stocking operation in the store 200.

Alternatively, outputting the result of comparison in a recognizable form may also be, for

example, adding a marker to the shelf stocking related information depending on the result of comparison. In this case, the marker may be added by, for example, drawing an underline or attaching an icon. If the result of comparison indicates “operation efficiency≥target value,” the second output controller 123A may add an OK (or GO) mark to the operation efficiency information displayed. On the other hand, if the result of comparison indicates “operation efficiency<target value,” the second output controller 123A may add an NG (or NO-GO) mark to the operation efficiency information displayed.

The second output controller 123A according to this embodiment has the result of comparison between each of the multiple pieces of shelf stocking related information and the evaluation index output in a recognizable form. Displaying the result of comparison in a recognizable form may be, for example, displaying, according to the result of comparison with the evaluation index, the multiple pieces of shelf stocking related information in different manners as shown in FIG. 5.

In FIG. 5, the evaluation index with respect to the days of inventory on hand, for example, includes first and second reference values, namely, “5 days” and “10 days.” If the days of inventory on hand is less than the first reference value “5 days” (e.g., if the days of inventory on hand is 4.7 days), then the days of inventory on hand is displayed in light green. If the days of inventory on hand is greater than the second reference value “10 days” (e.g., if the days of inventory on hand is 10.6 days), then the days of inventory on hand is displayed in dark red. If the days of inventory on hand is equal to or greater than the first reference value “5 days” and less than the second reference value “10 days” (e.g., if the days of inventory on hand is 5.3 days, 6.5 days, or 7.2 days), then the days of inventory on hand is displayed in orange (in an intermediate tone between light and dark colors).

In the same way, the evaluation index with respect to the occupancy rate also includes first and second reference values, namely, “75%” and “100%.” If the occupancy rate is less than the first reference value “75%” (e.g., if the occupancy rate is 72%), then the occupancy rate is displayed in light green. If the occupancy rate is greater than the second reference value “100%” (e.g., if the occupancy rate is 105%), then the occupancy rate is displayed in dark red. If the occupancy rate is equal to or greater than the first reference value “75%” and less than the second reference value “100%” (e.g., if the occupancy rate is 80% or 93%), then the occupancy rate is displayed in orange (in an intermediate tone between light and dark colors).

### (7-7) Determination of Evaluation Index Based on Standard Man-Hour

The evaluation index is determined, with respect to each of the one or more types of operations described above, by the standard man-hour of the operation. As used herein, the standard man-hour refers to the standard man-hour that forms a single operation. The standard man-hour is determined based on, for example, the sales and transaction volume for a certain period (e.g., one year). In this embodiment, the processor 12A determines, by a predetermined algorithm, the standard man-hour with respect to each of various types of operations based on the annual sales and transaction volume and then determines, by a predetermined algorithm, the evaluation index with respect to each of the various types of operations based on the standard man-hour thus determined.

More specifically, the acceptor 11A accepts the annual sales and transaction volume of the store 200 and the processor 12A determines, by a predetermined algorithm, the workload per day based on the annual sales and transaction volume thus accepted. Next, the processor 12A determines, by a predetermined algorithm, the standard man-hour of each of various types of operations, including the request operation, the picking operation, and the display operation, based on the workload thus determined, and converts the standard man-hour thus determined into a target value per unit time (e.g., per hour).

The target value according to this embodiment is the amount of time it takes to have a given operation done per unit number of times of execution (i.e., once). For example, the target value of the request operation may be determined to be “24 minutes per unit number of times of execution.” Alternatively, the target value may also be the time it takes to have a unit of the operation (such as one box or one cart) done. For example, the target value of the picking operation may be determined to be “0.6 minutes per box.” Still alternatively, the target value may also be calculated by dividing the number of times of the operation has been executed per unit time by the unit of the operation executed.

Optionally, the standard man-hour may also be determined in advance by a server (not shown), for example, the standard man-hour thus determined may be stored in the memory of the shelf stocking management device, and the processor 12A, for example, may determine the evaluation index based on the standard man-hour thus stored. Alternatively, an evaluation index that has been determined in advance based on the standard man-hour may be stored in the memory and the processor 12A, for example, may perform the processing such as comparison by using the evaluation index thus stored.

This enables making evaluation using an evaluation index based on the standard man-hour.

Note that if the first output controller 122A has the first number of unavailable products information and the second number of unavailable products information output, then the second output controller 123A may have a result of comparison between each of the first number of unavailable products information and second number of unavailable products information and the evaluation index output in a recognizable form. This makes it easier to analyze and evaluate the shelf stocking operation.

### (7-8) Operation of Shelf Stocking Management Device

The shelf stocking management device 1A operates in the following manner. For example, when the availability acceptor 211 accepts the availability information in the saleroom terminal 20, the outputter 22 outputs the availability information to the shelf stocking management device 1A. Alternatively, when the quantity of inventory acceptor 311 accepts the quantity of inventory information in the storage terminal 30, the outputter 32 outputs the quantity of inventory information to the shelf stocking management device 1A.

When the acceptor 11A receives either the availability information or the quantity of inventory information in the shelf stocking management device 1A, the processor 12A holds the information thus accepted. In addition, the processor 12A performs information processing using the information thus held and holds the result of the information processing thus performed in an internal memory, for example.

In the memory (not shown) of the shelf stocking management device 1A, timing information about the timing to output the information is stored. When finding that the current time agrees with the timing indicated by the timing information, the processor 12A has the processing result held output via the outputter 13A.

### (7-9) Saleroom Terminal

The saleroom terminal 20 includes an acceptor 21 and an outputter 22. The acceptor 21 includes the availability acceptor 211. Although the availability acceptor 211 is included in the saleroom terminal 20 in this embodiment, the availability acceptor 211 may be included in the shelf stocking management device 1A instead.

The acceptor 21 that forms part of the saleroom terminal 20 accepts various types of information. Examples of the various types of information include the availability information. In addition, the acceptor 21 also accepts the number of currently available products (to be de scribed later).

The availability acceptor 211 that forms part of the acceptor 21 accepts the availability information. For example, in the place where each product is displayed in the saleroom 201, the product identifier of the product is affixed in the form of a barcode, for example. If there is any unavailable product in the saleroom 201, then the salesclerk may read the product identifier of the product using a camera of the saleroom terminal 20. In the memory (not shown) of the saleroom terminal 20, a store identifier of the store 200 is stored. As soon as the product identifier is read, the availability acceptor 211 accepts, as the availability information, a set of multiple pieces of information about the store identifier stored, the product identifier that has been read, and a flag indicating that the product is unavailable.

### (7-10) Warehouse Terminal

The storage terminal 30 includes an acceptor 31 and an outputter 32. The acceptor 31 includes a quantity of inventory acceptor 311. Although the quantity of inventory acceptor 311 is included in the storage terminal 30 in this embodiment, the quantity of inventory acceptor 311 may be included in the shelf stocking management device 1A instead.

The acceptor 31 that forms part of the storage terminal 30 accepts various types of information. Examples of the various types of information include the quantity of inventory information.

The quantity of inventory acceptor 311 that forms part of the acceptor 31 accepts the quantity of inventory information. For example, in the place where each product is stored in the storage 202, the product identifier of the product is affixed in the form of a barcode, for example. The salesclerk may read the product identifier of the product using a camera of the storage terminal 30 and then enter the quantity of inventory via an input device such as a touchscreen panel.

In the memory (not shown) of the storage terminal 30, the store identifier of the store 200 is stored. When the product identifier is read, the quantity of inventory acceptor 311 accepts, as the quantity of inventory information, the store identifier stored, the product identifier that has been read, and the quantity of inventory information thus entered.

### (7-11) Exemplary Use of Shelf Stocking Management System

For example, the quantity of inventory acceptor 311 of the storage terminal 30 accepts the quantity of inventory information about the product-by-product or group-by-group quantity. The information generator 121A of the shelf stocking management device 1A generates quantity of inventory information about the total quantity of all products based on the quantity of inventory information thus accepted. Then, the first output controller 122A of the shelf stocking management device 1A may control the respective outputters (13A, 22, 32) of the shelf stocking management device 1A, the saleroom terminal 20, and the storage terminal 30 to allow only the total quantity to be output at the headquarters 300 and to allow not only the total quantity but also the product-by-product or group-by-group quantity to be output in the store 200.

The quantity of inventory information about the total quantity of all products may be, for example, the average value of the product-by-product or group-by-group quantities. In this case, the information generator 121A obtains the quantity of inventory information on either a product-by-product basis or a group-by-group basis with respect to either a product or group having a sales performance during a certain period in the past (e.g., during the last one month). Then, the information generator 121A calculates the sum of multiple pieces of quantity of inventory information thus obtained and divides the sum by either the number of products or the number of groups, thereby calculating the average value.

Specifically, in the storage 202, the salesclerk reads the product identifier in the place where the product is stored using the camera of the storage terminal 30 and enters the quantity of inventory via a touchscreen panel, for example. In the saleroom terminal 20, the availability acceptor 211 accepts the store identifier stored in the memory, the product identifier thus read, and the quantity of inventory thus entered as the quantity of inventory information of the product. Then, multiple pieces of quantity of inventory information thus accepted are transmitted to the shelf stocking management device 1A via the outputter 22.

In the shelf stocking management device 1A, the quantity of each type of products sold per day at the store 200 is stored in the memory (not shown). The acceptor 11A receives the multiple pieces of quantity of inventory information from the saleroom terminal 20. The information generator 121A acquires the days of inventory on hand by dividing, with respect to each of the multiple pieces of quantity of inventory information received, the quantity of inventory included in the quantity of inventory information by the quantity of each type of products sold per day to be identified by the product identifier included in the quantity of inventory information.

The information generator 121A calculates the sum of multiple numbers of days of inventory on hand thus acquired and divides the sum by the number of the pieces of the quantity of inventory information (i.e., the number of products) thus received, thereby calculating the average value of the days of inventory on hand of each product in the store 200.

For example, the shelf stocking related information may include the number of unavailable products information and the proportion. As used herein, the “proportion” refers to the ratio of the number of products currently available in the saleroom 201 to the number of products that should be available in the saleroom 201. The evaluation index includes a reference at or under which the shelves in the saleroom 201 need to be stocked (hereinafter simply referred to as a “reference”). The reference is set with respect to the proportion and may be, for example, 50%.

The first output controller 122A has the number of products, of which the proportion is equal to or less than the reference, other than the first type of unavailable products represented by the first number of unavailable products information, output in association with the first number of unavailable products information. In addition, the first output controller 122A also has the number of products, of which the proportion is equal to or less than the reference, other than the second type of unavailable products represented by the second number of unavailable products information, output in association with the second number of unavailable products information.

Optionally, the second output controller 123A may have the first number of unavailable products information, the second number of unavailable products information, and the number of products to be output in association with the first number of unavailable products information and the second number of unavailable products information displayed in mutually different manners.

Outputting the number of products, of which the proportion is equal to or less than the reference, in different manners in association with each of the temporarily unavailable in-stock products information and the unavailable out-of-stock products information makes it easier to recognize the difference in the degree of urgency of processing between the out-of-stock products and the products that are going to run out of stock.

Specifically, in the memory of the shelf stocking management device 1A, stored are pieces of on-screen image generation information for use to generate the on-screen images (refer to FIGS. The on-screen image generation information includes a plurality of display elements and arrangement information. As used herein, the “display elements” refer to elements displayed on the screen and the “arrangement information” refers to information indicating the arrangement of the plurality of display elements within the screen.

The first output controller 122A and the second output controller 123A generate on-screen images based on the on-screen image generation information stored in the memory and the shelf stocking related information generated by the information generator 121A and have the on-screen images output via the outputter 13A. As a result, an on-screen image such as the one shown in FIG. 5 is displayed on the monitor screen of the shelf stocking management device 1A (or on an external monitor screen in the headquarters 300).

The on-screen image shown in FIG. 5 is an on-screen image to be displayed first on the monitor screen of the shelf stocking management device 1A installed in the headquarters 300 (or on the external monitor screen in the headquarters 300) and will be hereinafter referred to as a “top on-screen image at the headquarters.”

The on-screen image shown in FIG. 5 includes: an item “store” corresponding to the store identifier; an item “days of inventory on hand” corresponding to the quantity of inventory information; an item “occupancy rate” corresponding to the occupancy rate information; an item “number of unavailable products” corresponding to the number of unavailable products information; an item “operation efficiency” corresponding to the operation efficiency information; and an item “comprehensive evaluation” corresponding to the result of comprehensive evaluation based on the quantity of inventory information, the occupancy rate information, the number of unavailable products information, and the operation efficiency information.

These six items are arranged in the order of “Store,” “Comprehensive Evaluation,” “Days of Inventory on Hand,” “Occupancy Rate”, “Number of Unavailable Products,” and “Operation Efficiency” from left to right on the first row of the on-screen image.

On the column of “Store” that is the leftmost item, the names of stores such as “Store A” and “Store B” are sorted by comprehensive evaluation and arranged from top to bottom in the ascending order (e.g., Stores B, A, D, C, and E in this example) such that the store with the lowest comprehensive evaluation is placed on the top of the list.

On the “Comprehensive Evaluation” column that is the second leftmost item, the grades, determined by comprehensive evaluation, of the respective stores (e.g., five numerical values from “1” indicating the lowest grade through “5” indicating the highest grade) are arranged top to bottom. The second output controller 123A shades the respective grades determined by comprehensive evaluation in the colors reflecting the results of comparisons with the evaluation indices used to make the comprehensive evaluation.

In this example, the evaluation indices used to make the comprehensive evaluations are a first reference value of “3” and a second reference value of “4.” Specifically, the color reflecting the result of comparisons with the evaluation indices is the color red as for the two grades “1” and “2” that are less than the first reference value of “3,” the color green as for the grade “5” greater than the second reference value of “4,” and the color orange as for the two grades “3” and “4” that are equal to or greater than the first reference value of “3” and equal to or less than the second reference value of “4.”

In FIG. 5, the color red is hatched in a dark shade, the color green is hatched in a light shade, and the color orange is hatched in an intermediate shade.

On the “Days of Inventory on Hand” column that is the third leftmost item, the numbers of days of inventory on hand (DOH) of the respective stores are arranged. The respective numbers of DOH are shaded in the colors reflecting the results of comparison with the evaluation indices used to calculate the DOH. In this example, the evaluation indices used to calculate the DOH are a first reference value of “5 days” and a second reference value of “10 days.” Specifically, the color reflecting the result of comparison with the evaluation indices is the color red as for the number of DOH of “10.6 days” greater than the second reference value of “5 days,” the color green as for the number of DOH of “4.7 days” less than the second reference value of “5 days,” and the color orange as for the three numbers of DOH of “6.5 days,” “5.3 days,” and “7.2 days” which are equal to or greater than the first reference value of “5 days” and equal to or less than the second reference value of “10 days.”

On the “Occupancy Rate” column that is the fourth leftmost item, the occupancy rates of the respective stores are arranged. The occupancy rates are shaded in the colors reflecting the results of comparison with the evaluation indices used to calculate the occupancy rates. In this example, the evaluation indices used to calculate the occupancy rate are a first reference value of “75%” and a second reference value of “100%.” Specifically, the color reflecting the result of comparison with the evaluation indices is the color red as for an occupancy rate of “105%” greater than the second reference value of “100%,” the color green as for an occupancy rate of “72%” less than the first reference value of “75%,” and the color orange as for the three occupancy rates of “80%,” “93%,” and “80%” which are equal to or greater than the first reference value of “75%” and equal to or less than the second reference value of “100%.”

On the “Number of Unavailable Products” column that is the fifth leftmost item, the numbers of unavailable products in the respective stores are arranged. The numbers of unavailable products are shaded in the colors reflecting the results of comparison with the evaluation indices used to calculate the numbers of unavailable products. In this example, the evaluation indices used to calculate the numbers of unavailable products are a first reference value of “15 SKU” and a second reference value of “30 SKU.” Specifically, the color reflecting the result of comparison with the evaluation indices is the color red as for the three numbers of unavailable products of “40 SKU,” “37 SKU,” and “155 SKU” greater than the second reference value of “30 SKU,” the color green as for the number of unavailable products of “13 SKU” short of the first reference value of “15 SKU,” and the color orange as for the number of unavailable products of “26 SKU” equal to or greater than the first reference value of “15 SKU” and equal to or less than the second reference value of “30 SKU.” Note that “SKU” stands for stock keeping unit that indicates the minimum handling unit of products (such as one dozen, 10 boxes, or 5 kg).

On the “operation efficiency” column that is the sixth leftmost item, the operation efficiencies of the respective stores are arranged. The operation efficiencies are shaded in the colors reflecting the results of comparison with the evaluation indices that are used to calculate the operation efficiencies. In this example, the evaluation indices used to calculate the operation efficiencies are a first reference value of “7” and a second reference value of “10.” Specifically, the color reflecting the result of comparison with the evaluation index is the color red as for two operation efficiencies of “6” and “5” less than the first reference value of “7,” the color green as for two operation efficiencies of “11” and “14” greater than the second reference value of “10,” and the color orange as for an operation efficiency of “8” equal to or greater than the first reference value of “7” and equal to or less than the second reference value of “10.”

In the on-screen image shown in FIG. 5, up and down arrows are annexed to each of the second to sixth items. When any of the two arrows annexed to any one of the six items is pressed down, a rearrangement instruction for that item is entered into the shelf stocking management device 1A. In the shelf stocking management device 1A, the acceptor 11A accepts the rearrangement instruction thus entered and the first output controller 122A controls the outputter 13A in accordance with the rearrangement instruction thus accepted, thereby changing the order of arrangement of the numerical values for that item from the ascending order to the descending order, or vice versa.

In addition, in the on-screen image shown in FIG. 5, each numerical value of each item is provided with a piece of increase/decrease information indicating whether the current numerical value has increased or decreased from the previous numerical value. The increase/decrease information includes, as a set, the rate of increase or decrease and either an up arrow indicating an increase or a down arrow indicating a decrease. Specifically, a memory (not shown) of the shelf stocking management device 1A stores the previous numerical values of the respective items. The first output controller 122A calculates, on an item-by-item basis, the rate of increase or decrease of the current numerical value from the previous numerical value and controls the outputter 13A based on the results of calculation, thereby displaying the increase/decrease information in association with the respective numerical values of the respective items.

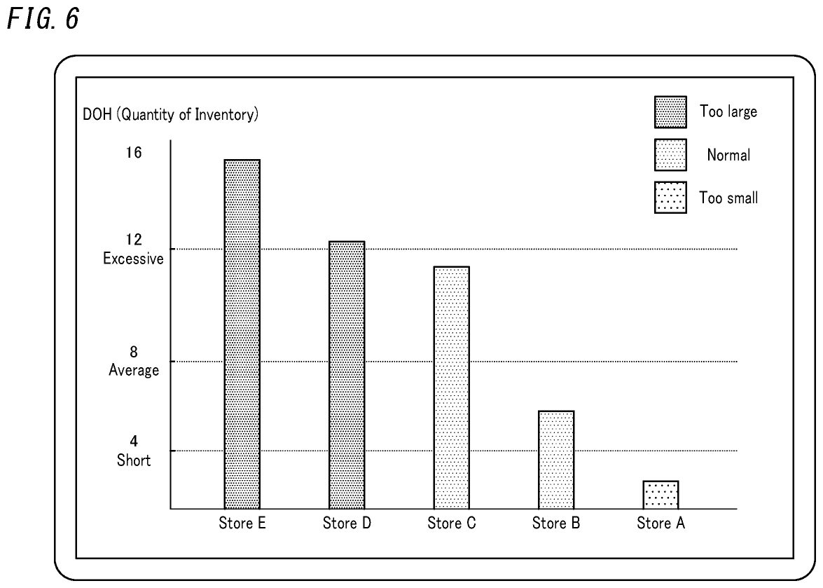

Selecting the item “DOH” on the on-screen image shown in FIG. 5 causes the image displayed on the monitor screen to change into an on-screen image as shown in FIG. 6. In the on-screen image shown in FIG. 6, the numbers of DOH of the respective stores 200 are shown in the form of a bar graph, of which the ordinate indicates the DOH. In this bar graph, the height of each bar represents the number of DOH and its color represents the result of comparison with the evaluation indices of the DOH. Note that the numerical values of the DOH in the on-screen image shown in FIG. 6 are different from the ones in the on-screen image shown in FIG. 5. In addition, the evaluation indices in the on-screen image shown in FIG. 6 are also different from the evaluation indices in the on-screen image shown in FIG. 5. Specifically, in FIG. 6, the first reference value is “4 days” and the second reference value is “12 days.”

The two bars representing the numbers of DOH of Stores E and D each have a height greater than the second reference value. Thus, the second output controller 123A instructs the outputter 13 to color these two bars in red indicating that the inventory is too large. The two bars representing the numbers of DOH of Stores C and B each have a height equal to or greater than the first reference value and equal to or less than the second reference value, and therefore, are colored in green indicating that the inventory is normal. The bar representing the number of DOH of Store A has a height less than the first reference value, and therefore, colored in blue indicating that the inventory is too small.

In FIG. 6, the color red is hatched in a dark shade, the color blue is hatched in a light shade, and the color green is hatched in an intermediate shade.

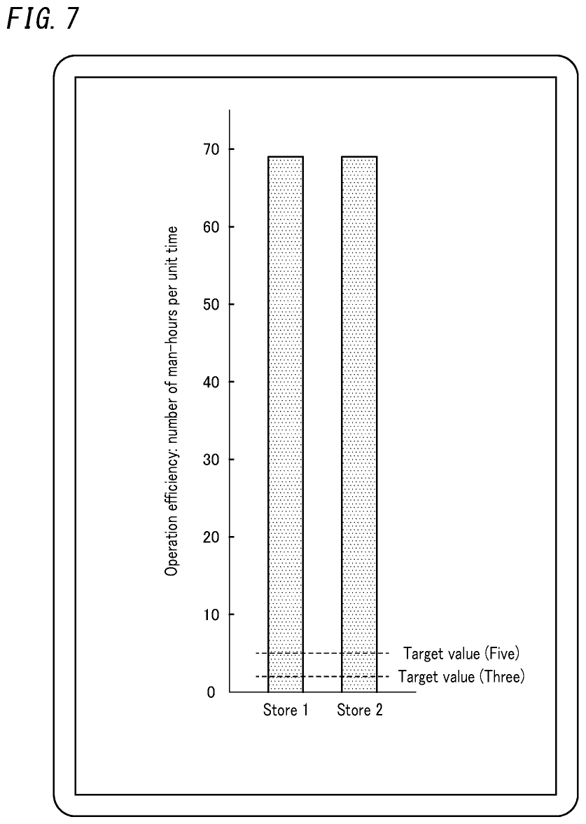

Selecting one numerical value associated with one store 200 (e.g., “14”) out of the plurality of numerical values (“6,” “5,” and so on) arranged in the “Operation Efficiency” column in the on-screen image shown in FIG. 5 causes the on-screen image on the monitor screen to change into the on-screen image shown in FIG. 7. In the on-screen image shown in FIG. 7, a bar graph, of which the ordinate indicates the operation efficiency, and the abscissa indicates the store 200, is shown. Note that the operation efficiency is herein represented by the number of man-hours per unit time.

In this bar graph, two bars representing the respective operation efficiencies of two stores 200, namely, a store 200 (Store E) associated with the numerical value selected and one or more stores 200 (Store C) colored in the same color (i.e., color green) as the former store 200, are shown along with two dotted lines indicating the two target values (namely, “5” and “3”) about the operation efficiency.

This allows the user to intuitively recognize the relationship between the operation efficiency of one store 200 and the target values. In addition, this also makes it easier to compare the operation efficiency of the one store 200 with the operation efficiency of another store 200, of which the operation efficiency is close to that of the one store 200.

In the example described above, selection of one numerical value is accepted and a bar graph providing data about two or more stores 200, consisting of one store 200 associated with the numerical value selected and one or more stores 200 associated with a numerical value colored in the same color as the numerical value selected, is displayed. However, this is only an example and should not be construed as limiting. Alternatively, selection of two or more numerical values may be accepted and a bar graph providing data about two or more stores 200 associated with the two or more numerical values selected may be displayed.

### (8) Third Embodiment

### (8-1) Plan Optimization System

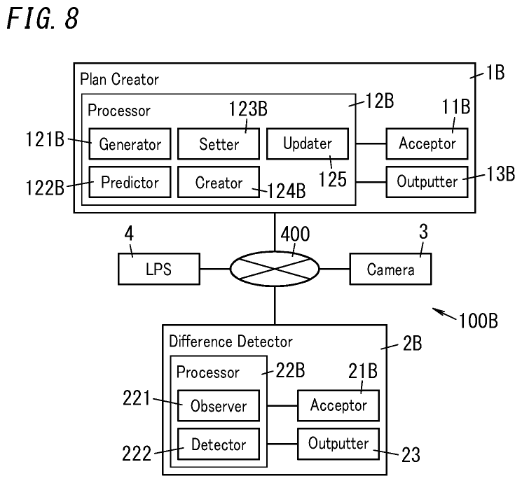

As shown in FIG. 8, a plan optimization system 100B according to a third embodiment of the present disclosure includes a plan creator 1B, a difference detector 2B, the camera 3, and the LPS 4.

The plan creator 1B is connected to, and ready to communicate with, the difference detector 2B, the camera 3, and the LPS 4 via the network 400. The network 400 may be, for example, a local area network (LAN), the Internet, or a communications network. Each of the plan creator 1B, the difference detector 2B, the camera 3, and the LPS 4 includes a communications module (not shown) that allows the plan creator 1B, the difference detector 2B, the camera 3, and the LPS 4 to communicate with each other via the network 400.

The plan creator 1B creates an operation plan (to be described later). The plan creator 1B includes a processor (such as a CPU, an MPU, or a GPU) and a memory (such as a semiconductor memory or a disc). Various types of data and programs are stored in the memory. The processor executes the programs using the various types of data, thereby performing the functions of the plan creator 1B. In the following description, the combination of the processor and the memory that perform various functions will be hereinafter sometimes referred to as a “computer.”

The difference detector 2B observes, through the camera 3 and the LPS 4, the operation being performed following the operation plan created by the plan creator 1B, and detects, based on the results of observation, a difference between the operation designed to be performed in the operation plan and the operation actually performed. Note that the difference detector 2B includes a processor and a memory. Various types of data and programs are stored in the memory. The processor executes the programs using the various types of data, thereby performing the functions of the difference detector 2B.

The camera 3 is installed on the spot where operations are performed to shoot a target of the operations (hereinafter referred to as an “operation target”) and personnel who are performing the operations (such as a salesclerk or a worker).

The LPS 4 is installed on the spot where operations are performed to detect the locations of the personnel (or articles) on the spot. Note that the LPS 4 is made up of a plurality of beacons and a plurality of scanners (none of which are shown in FIG. 8). Each of the beacons is carried by one of the persons of the personnel with him or her (or attached to one of the articles) to transmit a signal including personnel identification information to identify the person (or article identification information to identify the article). One of the scanners receives the signal from the beacon to detect the location of the person (or the article) based on the reception strength of the signal, the personnel identification information included in the signal, and the location information of the scanner itself.

The operations may be, for example, selling related operations. The selling activity may be, for example, sale of articles (such as foods and commodities) but may also be sale of services (such as food and drink services and accommodation services). The selling related operations are usually separately carried out by a plurality of departments such as cashiers, shelf stocking, and food processing. However, the operations are not necessarily carried out separately.

Alternatively, the operations may also be physical distribution related operations. The physical distribution related operations are usually carried out separately by a plurality of departments such as pickup and sorting. However, the operations are not necessarily carried out separately.

Still alternatively, the operations may also be article manufacturing related operations. The articles to manufacture may be any type without limitation. Note that the article manufacturing related operations are each broken down into two or more process steps, which are performed sequentially. Optionally, some of the two or more process steps may be performed in parallel with each other.

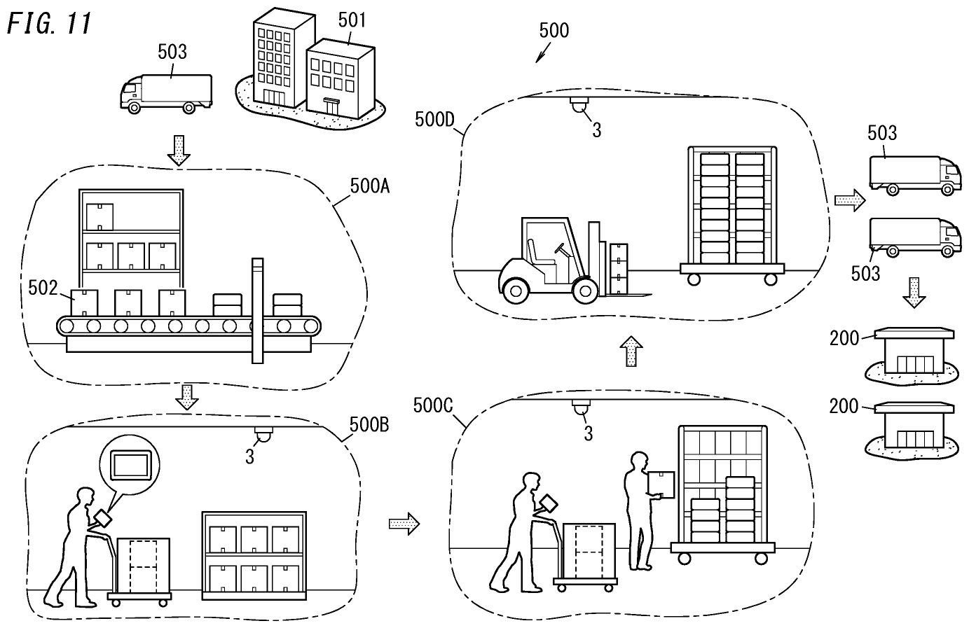

Furthermore, the operation to be broken down into two or more process steps is not necessarily related to manufacturing but may also be related to physical distribution or selling. In the following description, each of the two or more process steps that form a single operation will be hereinafter referred to as an “operation process step.” For example, the physical distribution shown in FIG. 11 (to be referred to later) includes a series of four operation process steps to be respectively carried out by a storage department 500A, a picking department 500B, a sorting department 500C, and a shipping department 500D. On the other hand, the selling shown in FIG. 12 (to be referred to later) includes a series of two operation process steps to be respectively carried out by a backroom department 200A and a store department 200B.

The place where the operations are carried out may be, for example, a store as the base of the selling but may also be a warehouse as the base of physical distribution.

The target of operation may be, for example, either a customer who visits the store or an article for sale to the customer (i.e., an article to be in stock at the store). Alternatively, the target of operation may also be an article to be handled by the physical distribution. Still alternatively, the target of operation may also be an article to be manufactured or a component thereof.

The store may be, for example, a store where they sell articles (such as a supermarket where they sell foods or a home improvement store where they sell commodities). The store may also be a store where they sell services (such as a restaurant that provides food and drink services or a hotel that provides accommodation services) or a factory where articles are manufactured.

The personnel who perform the operations may be salesclerks at the store but may also be workers at a warehouse or manufacturing crews at a factory. The personnel belongs to any of a plurality of departments such as the one described above and perform the operations assigned to the department. Note that the department to which the personnel belongs may vary from one period to another. For example, the personnel may belong to a cashier department in one period and belong to a shelf stocking department in another period. Alternatively, the department to which the personnel belongs may also be fixed.

### (8-2) Plan Creator

### (8-2-1) Overview

As shown in FIG. 8, the plan creator 1B according to the third embodiment of the present disclosure includes an acceptor 11B, a processor 12B, and an outputter 13B. Alternatively, the plan creator 1B may include only the processor 12B, while the acceptor 11B and the outputter 13B may be included in a terminal device (such as a tablet computer or a smartphone) provided separately from the plan creator 1B. In addition, the acceptor 11B may also be provided separately from the outputter 13B.

The processor 12B includes a generator 121B, a predictor 122B, a setter 123B, a creator 124B, and an updater 125. Optionally, the generator 121B may be omitted from the (processor 12B of the) plan creator 1B.

The acceptor 11B accepts various types of information. Examples of the various types of information include a standard man-hour (to be described later) and difference information (to be described later).

The acceptor 11B may accept, for example, the information (e.g., a standard man-hour) that has been entered through an input device such as a touchscreen panel or a keyboard and information (e.g., difference information) passed from another constituent element (such as the difference detector 2B) of the plan optimization system 100B.

Optionally, acceptance according to this embodiment may also include, for example, reception of information transmitted from an external device and acceptance of information that has been read out from a storage medium.

The processor 12B performs various types of processing. Examples of the various types of processing include processing to be performed by the generator 121B, the predictor 122B, the setter 123B, the creator 124B, and the updater 125. In addition, the processor 12B also makes various types of decisions (to be described later). Other types of processing will be described later as needed.

The outputter 13B outputs various types of information. Examples of various types of information include an operation plan (frame by frame and department by department operation plan) (to be described later), predicted man-hour values (frame by frame and department by department predicted man-hour values and predicted total man-hour value) (to be described later), and a predicted receiving quantity (to be described later).

The outputter 13B may output the information by displaying the information on a monitor screen, for example. Alternatively, the outputter 13B may also output the information by, for example, emitting a sound from a loudspeaker, printing out the information using a printer, transmitting the information to another device, or storing the information in a storage medium.

The outputter 13B may, for example, transform computer-processable information such as a predicted man-hour value into visually recognizable information for human beings and output the information either by displaying the information on a monitor screen or printing out the information using a printer, for example.

### (8-2-2) Prediction of Man-Hour

The predictor 122B that forms part of the processor 12B performs a prediction algorithm PA (to be described later) using a model PM (to be described later), thereby acquiring one or more predicted man-hour values PV2 for one or more periods in the future.

As used herein, the “period” refers to, for example, either one day or multiple time frames (such as sometime between 0 and 1, sometime between 1 and 2, . . . and sometime between 23 and 24) that form the day. Nevertheless, the period does not have to be defined on an hourly basis but may also be defined, for example, on a 15-minutes basis, on a 30-minutes basis, or on a 2-hours basis, for example. Alternatively, the period may also be defined on a weekly basis or on a monthly basis. That is to say, the time length of each period is not limited to any particular value. Alternatively, one day may also be divided more broadly into the periods of, for example, either the morning and the afternoon or early in the morning, daytime, and nighttime.

If the one or more periods are two or more periods, the two or more periods are usually continuous with each other but may also be discontinuous from each other. Also, the two or more periods usually have the same length but may also have mutually different lengths.

The model according to this embodiment is a model that receives, as input, a dataset for prediction DP (to be described later) and outputs a predicted man-hour value.

### (8-2-2a) Dataset for Prediction

The dataset for prediction includes, as a set, period identification information (time frame identification information TI (to be described later)), period attribute information (day attribute information AI (to be described later)), and quantity information (predicted number of visitors PV1 (to be described later)).

As used herein, the “period identification information” refers to a piece of information that identifies the period. The period may be either a period in the future or a period in the past. A period in the future corresponds to the second period according to the first embodiment and a period in the past corresponds to the first period according to the first embodiment. The period identification information may be, for example, either date identification information or time frame identification information. The time frame identification information may include, as a set, a start time and an end time. Alternatively, the time frame identification information may also include, as a set, a start time and the time length. Also, if the time length is a fixed value, the time frame identification information may consist of only the start time. Also, the time is usually expressed by the day, month, and year and by the minute and hour. If unnecessary, the minute and hour part or the minute part may be omitted. Each of the start time and the end time may be expressed by the day, month, and year if the period is defined on a daily basis and may be expressed by the hour, day, month, and year if the period is defined on an hourly basis.

As used herein, the “period attribute information” refers to a piece of information about the attribute of the period. If the period is one day, then the period attribute information is attribute of the day information. Examples of the attribute of the day information may be the day of the week (from Sunday through Saturday), the category of the day of the week (i.e., either a weekday or one of weekends and holidays), and a bargain day flag. The attribute of the day information may also be a holiday flag or a non-business day flag. As used herein, the “bargain day flag” refers to a flag indicating whether a certain day is a bargain day or not. The “holiday flag” herein refers to a flag indicating whether a certain day is a holiday or not. The “non-business day flag” herein refers to a flag indicating whether a certain day is a non-business day or not.

Note that if the period is the time frame, then period attribute information is time frame attribute information. Examples of the time frame attribute information include a bargain hours flag and a shortened business hours flag. The “bargain hours flag” herein refers to a flag indicating whether the time frame in question belongs to bargain hours or not. The “shortened business hours flag” herein refers to a flag indicating whether the time frame in question belongs to non-business hours in a situation where the business hours are shortened under some circumstances.

As used herein, the “quantity information” refers to a piece of information about the quantity of the operation targets during the specified period. The operation target is either a customer who visits the store (hereinafter referred to as a “visitor”) or an article as described above. In the case of selling, the quantity information may be, for example, number of visitors information about the number of visitors who visited the store during the specified period or receiving quantity information about the quantity of articles that arrived at the store during the specified period. In the case of physical distribution, the quantity information may be, for example, handleable quantity information about the quantity of articles that may be handled during the specified period. In the case of manufacturing, the quantity information may be, for example, shipment quantity information about the quantity of articles that may be shipped during the specified period.

In the case of selling, the quantity information may be, for example, the number of visitors information. The number of visitors information is preferably a predicted number of visitors but may also be an actual number of visitors (which may be either measured automatically or entered manually). As used herein, the “predicted number of visitors” refers to the number of customers who are predicted to visit the store, while the “actual number of visitors” refers to the number of customers who actually visited the store.

The predicted number of visitors may be, for example, the number of visitors predicted by either a human being or a machine and is acquired from an external device (such as the server of the store). Alternatively, the predicted number of visitors may also be a value acquired by using a number of visitors prediction model. For example, the predictor 122B may predict the number of visitors using the number of visitors prediction model to acquire the predicted number of visitors.

As used herein, the “actual number of visitors” refers to a value measured automatically by using either a sensor (not shown) provided at the entrance of the store or the camera 3 and the LPS 4. Alternatively, the actual number of visitors may also be a value that has been manually entered by a human being. The actual number of visitors may be acquired from, for example, an external device.

Particularly, in the case of sale of articles, the quantity information may be the receiving quantity information. The receiving quantity information is preferably a predicted receiving quantity value but may also be an actual receiving quantity value. As used herein, the “predicted receiving quantity value” refers to the quantity of articles that are predicted to arrive at the store, while the “actual receiving quantity value” refers to the quantity of articles that have actually arrived at the store.

Note that in the case of physical distribution, the quantity information may be, for example, the handleable quantity information. The handleable quantity information is usually the quantity of articles that have been actually handled but may also be the quantity of articles that are predicted to be handled.

As used herein, the “predicted man-hour value” refers to the result of prediction of the operation man-hour during any of these periods. As used herein, the “operation man-hour” refers to the number of man-hours required to perform the operation. The “man-hour” is a numerical value indicating the workload and is expressed as the product of the hours and the number of persons required. Note that the unit of the man-hour may be, for example, man-hours. Alternatively, any of the units of time (such as minutes, hours, or days) may also be used as it is as the unit of the man-hour.

Note that in this embodiment, the amount of the operation (workload) is expressed by the man-hour. That is to say, each of the various types of operations described above has its workload converted into man-hour. Also, total man-hours may be obtained by adding together the respective numbers of man-hours of multiple operations. This enables comparing the workloads between multiple different types of operations and calculating a total of the workloads. The workload may be converted into man-hour either manually by human hands or by using a predetermined algorithm, whichever is appropriate.

### (8-2-2b) Prediction Algorithm

The prediction algorithm corresponds to a learning algorithm for use in the machine learning to be performed by the generator 121B (to be described later). Specifically, the prediction algorithm herein refers to an algorithm that allows the generator 121B to acquire the predicted man-hour value by using a model generated by machine learning.

Alternatively, the prediction algorithm may also be an algorithm for acquiring the predicted man-hour value by using a model that has been generated by a technique other than machine learning (e.g., a linear prediction model based on statistical data).

Note that the machine learning for generating the man-hour prediction model is preferably supervised learning but may be unsupervised learning or reinforcement learning as well. In this embodiment, the machine learning is supposed to be light gradient boosting machine (GBM). However, this is only an example and should not be construed as limiting. The machine learning may be the decision tree or any other suitable algorithm as well.

### (8-2-3) Setting of Standard Man-Hour

The setter 123B sets a standard man-hour for operations. Note that the standard man-hour that has been set may be stored, for example, in the memory of the plan creator 1B. However, the standard man-hour may also be stored in any other location without limitation.

As used herein, the “standard man-hour” refers to a standard man-hour with respect to the operations. The standard man-hour is the sum of the man-hour required to perform the operation (i.e., the net operation hours) and some float slack such as break time.

The standard man-hour may be set manually, for example. Specifically, a numerical value representing the standard man-hour is entered by a human being via an input device such as a touchscreen panel. In the plan creator 1B, the acceptor 11B accepts the numerical value thus entered and the setter 123B sets the numerical value thus accepted as the standard man-hour.

Alternatively, the standard man-hour may also be set automatically. Specifically, in that case, the setter 123B performs an algorithm that receives, as input, the quantity information described above and personnel information, and outputs the standard man-hour, thereby setting the standard man-hour.

As used herein, the “personnel information” refers to a piece of information about the personnel. The personnel information includes personnel identification information. Examples of the personnel identification information include name and address. cellphone number, and email address. Alternatively, the personnel identification information may also be an ID associated with the name and address. The personnel information is acquired, for example, from an external device (such as the server of the store). Optionally, part of the personnel identification information (such as days-off information (to be described later)) may also be manually entered by the personnel.

Also, the personnel information usually includes work record information and days-off information. As used herein, the “work record information” refers to a piece of information about the work record of the personnel. The work record information is either a set of multiple pieces of information including the period identification information or a set of multiple pieces of information including the period identification information and the department identification information.

As used herein, the “days-off information” refers to a piece of information about the days off that the personnel plan to take. The days-off information may be, for example, a set of multiple pieces of information including the period identification information. The pieces of period identification information that form the days-off information are usually dates but may also be either information indicating which half of the day the personnel plan to take a day-off (i.e., in the morning or in the afternoon) or which time frame the personnel plan to take a day-off.

Note that the days-off information is specifically a set of the dates on which the personnel plan to take days off, for example. Alternatively, the days-off information may also be days off flags attached to the dates when the personnel plan to take days off among the plurality of dates on calendar information. That is to say, the days-off information may also be a part of work schedule information (to be described later).

Optionally, the personnel information may further include skill information. As used herein, the “skill information” refers to a piece of information about the skills of the personnel in performing the operations. The skill information may be, for example, a set of multiple pieces of department identification information that identifies the department that the personnel may be in charge of. Optionally, the skill information may also include, for example, information about the number of years of experience at the operation and the social status and qualification of the personnel.

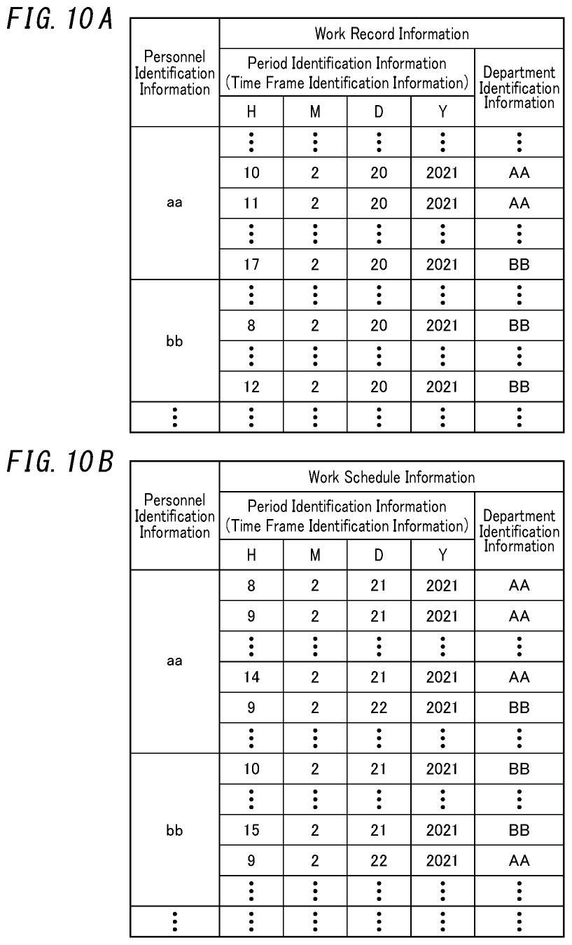

Optionally, the personnel information may include work schedule information. As used herein, the “work schedule information” refers to a piece of information about the work schedule of the personnel. The work schedule information may be, for example, a set of multiple pieces of information including the period identification information and department identification information (refer to FIG. 10B). Nevertheless, if there is only one department, then the work schedule information may be a set of multiple pieces of period identification information (not shown).

Specifically, the work schedule information may be, for example, a set of multiple pieces of information about the date of a scheduled workday, the working start time, and the name of the department to which the personnel belongs. If the personnel are supposed to be work for regular working hours, then the working start time may be omitted from the work schedule information. Also, if there is only one single department, then the name of the department may be omitted from the work schedule information. Alternatively, the work schedule information may also be a set of multiple pieces of information about the working start time and the name of the department or a set of multiple pieces of information about the working start time and a workday flag attached to each of the dates on which the personnel plan to report to work among the plurality of dates on calendar information.

Note that the work schedule information is a part, corresponding to a single piece of personnel identification information, of the operation plan (to be described later). That is to say, the work schedule information is acquired, after the operation plan has been created by the creator 124B (to be described later), from the operation plan thus created. Nevertheless, an initial value of the work schedule information is a piece of information that has been manually entered by the personnel and may be updated afterward by the operation plan created by the creator 124B.

The setter 123B according to this embodiment sets the department-by-department standard man-hour based on department information as well. As used herein, the “department information” refers to a piece of information about a plurality of departments that are separately in charge of the operations. The department information may be, for example, a set of multiple pieces of information including the department identification information and order of priority information. As used herein, the “department identification information” refers to a piece of information for use to identify the department. The department identification information may be, for example, the name of the department such as “cashier” or “shelf stocking” but may also be, for example, an ID associated with the name of the department. As used herein, the “order of priority information” refers to a piece of information about the order of priority between the departments. The order of priority information may be, for example, a numerical value indicating the priority level (such as “1” or “2”).

As used herein, the set of multiple pieces of information including the department identification information and the order of priority information may be, for example, “(cashier, 1), (shelf stocking, 2), and so on.” Alternatively, the department information may also be multiple pieces of department identification information that are arranged according to the order of priority (e.g., “cashier, shelf stocking, and so on”).

Nevertheless, the order of priority information is not essential. Alternatively, the department information may also be a set of multiple pieces of department identification information corresponding to a plurality of departments.

Optionally, the multiple pieces of department identification information may be hierarchized (e.g., into stores, divisions inside each of the stores, and teams inside each of the divisions). For example, the department of the highest order may be “store,” the department of the second highest order may be “division” inside the store, and the department even lower in order than the division may be “team” inside the division.

Optionally, the setter 123B may set the standard man-hour with the cost taken into account based on sales information about the sales attained by the operation, for example.

Note that in the case of manufacturing articles, the standard man-hour may be set on a process step basis.

### (8-2-4) Plan Creation

The creator 124B creates an operation plan based on at least the standard man-hour set by the setter 123B, one or more predicted man-hour values acquired by the predictor 122B, and one or more pieces of personnel information about one or more persons belonging to the personnel who perform the operation. The number of persons belonging to the personnel who perform the operation is usually two or more but may also be one. Therefore, the number of pieces of personnel information for use to create the operation plan is usually two or more but may also be one. In the following description, the number of the persons belonging to the personnel is supposed to be two or more and the number of pieces of the personnel information is supposed to be two or more. The operation plan thus created may be stored in, for example, the memory of the plan creator 1B but may also be stored anywhere else without limitation.

As used herein, the “operation plan” refers to a plan of the operation that will be performed by two or more persons belonging to the personnel for one or more second periods in the future. The operation plan according to this embodiment herein refers to a set of two or more pieces of work schedule information corresponding to two or more pieces of personnel identification information as shown in FIG. 10B. The work schedule information is a set of multiple pieces of information including the period identification information and the department identification information as described above.

Note that the work schedule information corresponding to a piece of personnel identification information “aa,” for example, includes “{(8, 2, 21 2021), AA}, {(9, 2, 21 2021), AA}, . . . {(14, 2, 21 2021), AA}, {(9, 2, 22 2021), BB} , and so on.”

Alternatively, the operation plan may also consist of, for example, a shift plan and a personnel plan. As used herein, the “shift plan” refers to a plan about the work schedules (shift) of a plurality of persons belonging to the personnel. The shift plan refers to a piece of information indicating which persons of the personnel plan to perform the operation during what period (e.g., what day) and may be a set of multiple pieces of information including, for example, the personnel identification information and the period identification information (e.g., date identification information). As used herein, the “personnel plan” refers to a plan about the assignment of the persons belonging to the personnel who plan to work to respective departments. The personnel plan may be, for example, a set of multiple pieces of information including the personnel identification information, the department identification information, and the period identification information (e.g., time frame identification information).

Note that this is only an example and should not be construed as limiting. Rather, the operation plan may have any other data structure without limitation.

The creator 124B according to this embodiment creates the frame-by-frame and department-by-department operation plan based on the department information as well. Optionally, the operation plan may also be created with constraints other than the personnel (skills) and the department (order of priority) taken into account as well.

The creator 124B according to this embodiment creates the operation plan by using a creation algorithm which receives, as input, a dataset for creation including, for example, standard man-hour, one or more predicted man-hour values, and two or more pieces of personnel information, and which outputs the operation plan.

### (8-2-5) Update of Standard Man-Hour

The updater 125 updates, in accordance with the difference information provided by the difference detector 2B, the standard man-hour that has been set by the setter 123B.

Specifically, the memory of the plan creator 1B, for example, stores the standard man-hour that has been set by the setter 123B. The acceptor 11B accepts the difference information provided by the difference detector 2B. The updater 125 updates the standard man-hour stored in the memory to narrow the difference represented by the difference information thus accepted. Specifically, the memory of the difference detector 2B, for example, holds the difference information for the current period. The updater 125 causes either an increment or a decrement to the current standard man-hour in the memory when a transition is made from the current period to the next period. Meanwhile, when the transition is made from the current period to the next period, the updater 125 acquires the difference information from the difference detector 2B and compares the difference information thus acquired with the difference information held in the memory. If the result of comparison reveals that the difference has narrowed, the updater 125 maintains the standard man-hour, to which either the increment or the decrement has been caused. On the other hand, if the result of comparison reveals that the difference has widened, then the updater 125 changes the standard man-hour, to which either the increment or the decrement has been caused, back to the previous standard man-hour again.

Performing this series of processing steps repeatedly allows the standard man-hour to be updated gradually to narrow the difference between the planned man-hour and the actual man-hour.

### (8-2-6) Model Generation

The generator 121B generates a model by performing a machine learning algorithm LA (to be described later) using two or more datasets for learning DT (to be described later). Note that the model thus generated may be stored, for example, in the memory of the plan creator 1B but may also be stored anywhere else without limitation.

Specifically, the generator 121B performs the machine learning algorithm by using, with respect to each of the two or more datasets for learning, a part (hereinafter referred to as a “first part”) of the dataset for learning as input data and another part (hereinafter referred to as a “second part”) of the dataset for learning as training data.

The first part is a part to be shared with the dataset for prediction and may be a set of multiple pieces of information including the period identification information, the period attribute information, and the quantity information. The second part is a part corresponding to the output of a prediction model and may be, for example, an actual man-hour value.

This allows the relation between the first part and the second part to be learned, thus generating a prediction model that outputs a predicted value of the second part with respect to the unknown first part.

Performing the machine learning algorithm using two or more datasets for learning may be, for example, generating a prediction model by entering an input value (training data) of the dataset for learning into an input layer of the prediction model and entering the output value of the dataset for learning into an output layer of the prediction model. The dataset for learning includes a set of multiple pieces of information including the period identification information, the period attribute information, and the quantity information and an actual man-hour value AV (to be described later).

As used herein, the “actual man-hour value” refers to an actual man-hour required to perform the operation during the period. The actual man-hour value is acquired based on two or more pieces of work record information (refer to FIG. 12A; as will be described later) about two or more persons belonging to the personnel.

In this embodiment, the operation is selling related operation. The selling may be sale of articles or sale of services, whichever is appropriate.

The target is a customer who visits the place where the selling is performed. The quantity information includes number of visitors information. The number of visitors information refers to a piece of information about the number of customers who visit the place during the period.

The number of visitors information includes a predicted number of visitors PV1 (to be described later). The predicted number of visitors is the number of customers that are predicted to visit the place during the period.

The period attribute information includes a bargain period flag. As used herein, the “bargain period flag” refers to a flag indicating whether the period belongs to a bargain period or not. Examples of the bargain period include a bargain day and bargain hours. Examples of the bargain period flag include a bargain day flag and a bargain hours flag.

The period attribute information further includes weather information. As used herein, the “weather information” refers to a piece of information about the weather during the period in the place where the operation is performed. The weather information may be, for example, an actual value but may also be a predicted value. The weather information may be acquired from a server of the Japan Meteorological Agency, for example.

The period may be, for example, each of two or more time frames belonging to one day. In that case, the setter 123B sets a standard man-hour with respect to each time frame defined to perform the operation. The predicted number of visitors refers to the number of visitors that are predicted for the one day to which the two or more time frames belong. The predicted man-hour value includes a frame-by-frame predicted man-hour value.

The operation may be separately performed by two or more departments. Examples of the two or more departments include multiple stores belonging to the same business enterprise, multiple divisions belonging to the same store, and multiple teams belonging to the same division.

In that case, one or more persons of the personnel who perform the operation belong to each of the two or more departments. The operations are usually performed by the respective departments in parallel with each other but may also be performed sequentially. The setter 123B sets the frame-by-frame standard man-hour and the department-by-department standard man-hour. The predicted man-hour value includes a frame-by-frame predicted man-hour value and a department-by-department predicted man-hour value.

The processor 12B determines, for example, whether the input dataset is to be used for prediction purposes or learning purposes and passes the dataset to an algorithm corresponding to the decision made. The decision may be made based on, for example, a result of comparison between the date (day/month/year) included in the current time information and the date included in the dataset.

Specifically, the processor 12B acquires the current time information from, for example, a clock built in the processor or a network time protocol (NTP) server and compares the date included in the current time information thus acquired with the date included in the dataset. If the result of comparison reveals that the date included in the dataset is anterior to the date included in the current time information, then the processor 12B decides that the dataset be used for learning and passes the dataset to the learning algorithm. On the other hand, if the result of comparison reveals that the date included in the dataset is the same as, or posterior to, the date included in the current time information, then the processor 12B decides that the dataset be used for prediction and passes the dataset to the prediction algorithm.

Optionally, when determining whether to pass the dataset, the processor 12B may determine whether any operation need to be performed on the day specified by the date included in the dataset and may pass the dataset only when decision is made that some operation needs to be performed. That is to say, the processor 12B does not have to pass the dataset when deciding that no operation need to be performed.

In this case, the decision is made based on, for example, a non-business day flag or shortened business hours flag included in the dataset. However, this is only an example and should not be construed as limiting. Alternatively, the processor 12B may also make a decision using a need for operation prediction model without depending on the non-business day flag, for example. As used herein, the “need for operation prediction model” refers to a model that receives the dataset for prediction as input and that outputs a flag indicating whether any operation needs to be performed. The need for operation prediction model may be generated by, for example, making the generator 121B perform the machine learning algorithm using the first part of the dataset for learning as input data and the second part of the dataset for learning as training data.

### (8-2-7) Details of Model

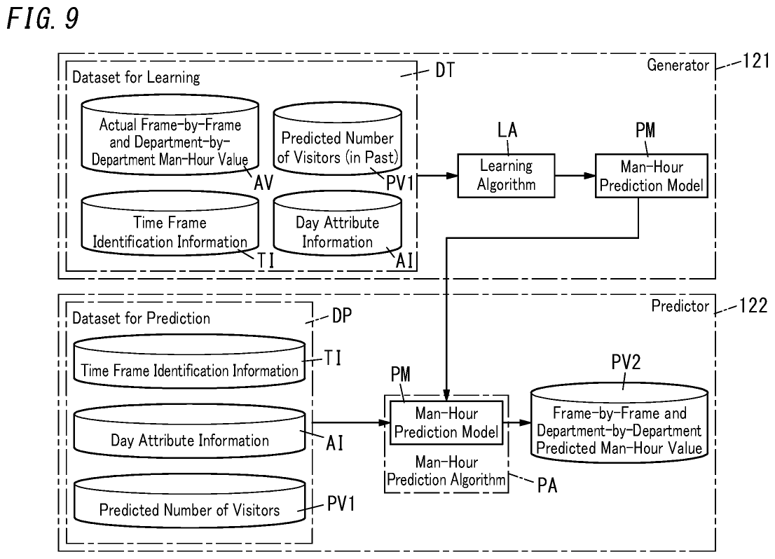

The model according to this embodiment is a man-hour prediction model PM which receives the dataset for prediction DP as input and outputs the frame-by-frame and department-by-department predicted man-hour value PV2 as shown in FIG. 9.

The dataset for prediction DP includes, with respect to each of two or more times frames in the future, a set of multiple pieces of information including time frame identification information TI, day attribute information AI, and predicted number of visitors PV1. As used herein, the “time frame identification information TI” refers to a piece of information that identifies the time frame. The day attribute information AI refers to a piece of information about the attribute of the day to which the time frame belongs. The predicted number of visitors PV1 is the number of customers that are predicted to visit the store for the day to which the time frame belongs.

The dataset for prediction DP is associated with the department identification information. As used herein, the “department identification information” refers to a piece of information for use to identify the department.

The predictor 122B performs, with respect to each of the two or more pieces of department identification information, a man-hour prediction algorithm PA based on the man-hour prediction model PM by using the dataset for prediction DP associated with the department identification information as input, thereby acquiring, on a department-by-department basis, two or more predicted man-hours values associated with the two or more time frames in the future.

As can be seen, according to this embodiment, single-stage prediction is performed to predict the frame-by-frame and department-by-department man-hour directly based on the dataset for prediction DP.

This embodiment contributes to further improving the accuracy of the frame-by-frame and department-by-department man-hour prediction by making the single-stage prediction based on the man-hour prediction model PM.

In addition, according to this embodiment, the dataset for learning is the dataset for learning DT. The dataset for learning DT includes, for each of two or more time frames in the past, a set of multiple pieces of information including the time frame identification information TI, the day attribute information AI, and the predicted number of visitors PV1, and an actual frame-by-frame and department-by-department man-hour value AV.

As used herein, the actual frame-by-frame and department-by-department man-hour value AV refers to an actual department-by-department man-hour that it takes to perform the operation in question in the given time frame. The dataset for learning DT is associated with the department identification information.

The generator 121B generates the man-hour prediction model PM by performing, with respect to each of two or more pieces of department identification information, a machine learning algorithm LA using the first part of the dataset for learning DT associated with the piece of department identification information as input data and using the second part thereof as training data.

As can be seen, according to this embodiment, the plan creator 1B may generate, by itself, the man-hour prediction model PM by performing machine learning using the first dataset for learning as a target (i.e., input data and training data; the same statement will be applicable to the rest of the description).

### (8-2-8) Update of Standard Man-Hour Based on Difference

The acceptor 11B accepts difference information provided by the difference detector 2B. As will be described later, the difference detector 2B makes the camera 3 or any other device observe the actual operation being performed based on the operation plan created by the plan creator (creator 124B) and detects, based on the operation plan and the result of the observation, the difference between the planned operation and the actual operation, thereby acquiring difference information.

The updater 125 updates, based on the difference information provided by the difference detector 2B, the standard man-hour that has been set by the setter 123B to narrow the difference.

The updater 125 may update the standard man-hour that has been set to bring the actual man-hour value acquired by the observer 221 closer toward the standard man-hour, for example.

Specifically, the updater 125 changes, to a predetermined amount every time in either an increasing direction or a decreasing direction (e.g., in the increasing direction), the standard man-hour set by the setter 123B (i.e., the standard man-hour held in the memory) to determine whether the difference information widens or narrows according to this change.

If the difference represented by the difference information provided by the difference detector 2B widens according to this change, then the updater 125 inverts the direction of change and performs the same operation as the one described above. That is to say, the updater 125 changes, to a predetermined amount every time in the opposite direction from the one described above (i.e., in the decreasing direction), the standard man-hour to determine whether the difference information widens or narrows according to this change.

If the difference represented by the difference information narrows according to this change, the updater 125 will perform the same operation continuously until the difference starts increasing (i.e., until the difference reaches a local minimum value). As a result, the standard value is updated into a value that makes the difference represented by the difference information a local minimum value.

Updating the standard man-hour in this manner allows the difference between the actual man-hour value and the standard man-hour to be narrowed either at once or gradually.

This contributes to narrowing the difference and eventually optimizing the operation plan.

### (8-2-9) Update of Predicted Man-Hour Value Based on Difference

The updater 125 updates the predicted man-hour value acquired by the predictor 122B to narrow the difference represented by the difference information provided by the difference detector 2B.

The updater 125 may update the predicted man-hour value to bring the actual man-hour value acquired by the observer 221 closer toward the standard man-hour, for example.

Specifically, the updater 125 changes, to a predetermined amount every time in either an increasing direction or a decreasing direction (e.g., in the increasing direction), the predicted man-hour value acquired by the predictor 122B (i.e., the predicted man-hour value held in the memory) to determine whether the difference represented by the difference information widens or narrows according to this change.

If the difference represented by the difference information provided by the difference detector 2B widens according to this change, then the updater 125 inverts the direction of change and performs the same operation as the one described above. That is to say, the updater 125 changes, to a predetermined amount every time in the opposite direction from the one described above (i.e., in the decreasing direction), the predicted man-hour value to determine whether the difference represented by the difference information widens or narrows according to this change.

If the difference represented by the difference information narrows according to this change, the updater 125 will perform the same operation continuously until the difference starts increasing (i.e., until the difference reaches a local minimum value). As a result, the predicted man-hour value is updated into a value that makes the difference a local minimum value.

Updating the predicted man-hour value in this manner allows the difference between the actual man-hour value and the standard value to narrow either at once or gradually.

This contributes to narrowing the difference and eventually optimizing the operation plan.

Note that the updater 125 preferably updates both the predicted man-hour value and the standard man-hour. That is to say, the updater 125 may, for example, update the predicted man-hour value to make the difference a local minimum value and then update the standard man-hour to make the difference another local minimum value (second local minimum value) smaller than the former local minimum value (first local minimum value).

Alternatively, the predicted man-hour value and the standard man-hour may be updated in reverse order instead. That is to say, the updater 125 may, for example, update the standard man-hour to make the difference a local minimum value and then update the predicted man-hour value to make the difference another local minimum value (second local minimum value) smaller than the former local minimum value (first local minimum value).

Still alternatively, the updater 125 may update the predicted man-hour value and the standard man-hour alternately and repeatedly. This contributes to further narrowing the difference.

Alternatively, the updater 125 may update only the predicted man-hour value without updating the standard man-hour. Still alternatively, the updater 125 may update only the standard man-hour without updating the predicted man-hour value. The difference may be narrowed in any case.

### (8-2-10) Update of Other Parameters

The updater 125 may update the operation plan created by the creator 124B to narrow, either at once or gradually, the difference between either the predicted man-hour value or the actual man-hour value and the standard man-hour.

Alternatively, the updater 125 may update a series of operation process steps that form the operation to narrow, either at once or gradually, the difference between either the predicted man-hour value or the actual man-hour value and the standard value.

Note that it will be described later in the “(9-3) Cooperation between departments” section how to update the operation plan and how to update a series of operation process steps that form the operation.

### (8-3) Difference Detector

As shown in FIG. 8, the difference detector 2B includes an acceptor 21B, a processor 22B, and an outputter 23. Alternatively, the difference detector 2B may include only the processor 22B, while the acceptor 21B and the outputter 23 may be included in a terminal device (such as a tablet computer) provided separately from the difference detector 2B.

The processor 22B includes an observer 221 and a detector 222.

The acceptor 21B accepts various types of information. Examples of the various types of information include an operation plan and countermeasure information.

The acceptor 21B accepts the operation plan from, for example, the plan creator 1B via the network 400. In addition, the acceptor 21B also accepts countermeasure information entered by an administrator.

The processor 22B performs various types of processing. Examples of the various types of processing include the processing to be performed by the observer 221 and the detector 222. The observer 221 observes the actual operation being performed following the operation plan created by the plan creator 1B. As used herein, the observation includes, for example, shooting the actual operation using the camera 3 and detecting locations using the LPS 4.

The observer 221 shoots the actual operation using the camera 3 to acquire image information about the personnel who performs the operation and the targets of the operation (such as visitors and articles). In addition, the observer 221 detects locations using the LPS 4 to acquire location information about the locations of the personnel and the targets in the place where the operation is performed (such as a store or a warehouse).

The detector 222 detects, based on the operation plan provided by the plan creator 1B and the result of observation (i.e., the image information and the location information) provided by the observer 221, the difference concerning man-hour between the planned operation and the actual operation, thereby acquiring difference information about the difference thus detected.

As used herein, the difference concerning man-hour may refer to the difference in man-hour itself or various types of gaps involved with the difference in man-hour, whichever is appropriate. Examples of the various types of gaps include the presence of idle personnel, of which the number is greater than a threshold value, the presence of a cashier queue, of which the length is greater than a threshold value, the presence, in a place where articles are displayed, of unavailable products, of which the number is greater than a threshold value, and the presence, in a place where articles are processed, of articles yet to be processed, of which the number is greater than a threshold value.

The detector 222 may detect, based on the image information and location information acquired by the observer 221, for example, various types of gaps such as these and may acquire, based on the various types of gaps thus detected, difference information representing the difference in man-hour. The difference information representing the difference in man-hour may be, for example, the difference (which usually has a positive or negative sign) between the actual man-hour and the man-hour included in the operation plan but may also be a flag indicating either excess or shortage (i.e., only a piece of information corresponding to either the positive sign or the negative sign).

Specifically, the detector 222 acquires gap information by using, for example, a gap detection model that receives, as input, the image information and the location information and outputs gap information about various types of gaps. Next, the detector 222 acquires difference information by using a difference detection model that receives the gap information as input and that outputs the difference information.

Note that the gap detection model is generated by performing a machine learning algorithm LA using a first part (a set of multiple pieces of information including the image information and the location information) of a dataset for learning (including a set of multiple pieces of information including the image information and the location information and gap information that has been entered manually by human hands) as input data and using a second part thereof (gap information) as training data. The difference detection model is generated by performing a machine learning algorithm LA using a first part (gap information) of a dataset for learning (including the gap information and difference information that has been entered manually by human hands) as input data and using a second part thereof (difference information) as training data.

Optionally, the (processor 22B of the) difference detector 2B may further include a generator (not shown) for generating the gap detection model and the difference detection model in this manner.

Nevertheless, as will be described later, the (outputter 23 of the) difference detector 2B may output, in a visualized form, the results of observation provided by the observer 221. A person who watches the visualized results of observation may recognize the difference and enter difference information about the difference thus recognized through an input device. Then, the difference detector 2B may accept the difference information thus entered.

The outputter 23 outputs various types of information. Examples of the various types of information include the difference information described above, countermeasure information (to be described later), and the results of observation (to be described later).

The outputter 23 passes, to the plan creator 1B, the difference information that has been acquired by the detector 222 by transmitting the difference information via the network 400, for example. The information does not have to be passed between devices via a communications medium such as the network 400 but may also be passed via a removable storage medium such as a memory card.

Optionally, the outputter 23 may output (e.g., display on a monitor screen), in a visualized form, the results of observation provided by the observer 221.

A person who watches the results of observation (e.g., an administrator who manages the operations) recognizes the gap such as the one described above and enters countermeasure information for use to narrow the gap via an input device such as a keyboard. Examples of the countermeasure information include information about the operation plan and management method of a department that causes a little gap and instructions on an increase or decrease in the number of personnel and change in their assignment.

In the difference detector 2B, the acceptor 21B accepts the countermeasure information thus entered and the outputter 23 outputs the countermeasure information thus accepted, along with the difference information, to the plan creator 1B. Optionally, the countermeasure information may be output to be included in the difference information.

In the plan creator 1B, the acceptor 11B accepts the difference information and the countermeasure information, the updater 125 updates the standard man-hour in accordance with the difference information, and the outputter 13B outputs, in a visualized form, the countermeasure information thus accepted. Optionally, the countermeasure information may be conveyed from the administrator directly to the personnel who performs the operation.

This contributes to optimizing the operation plan.

Note that the difference information described above may be either a piece of information about the total man-hour or a piece of information about frame-by-frame and department-by-department man-hour, whichever is appropriate.

### (8-4) Operation of Plan Optimization System

Next, it will be described how the plan optimization system 100B operates. In the following description, detailed description of respective components thereof will be omitted.

The plan creator 1B that forms part of the plan optimization system 100B may operate, for example, in the following manner.

When the acceptor 11B that forms part of the plan creator 1B accepts a dataset via an input device, the processor 12B determines, by comparing the date (day/month/year) included the current time information acquired from, for example, a clock built in the processor with the date (day/month/year) included in the dataset, whether the dataset thus accepted is intended for use in learning or not.

If a decision is made that the dataset be used for learning, then the dataset is stored in a dataset for learning area (not shown) in the memory. When a predetermined number of datasets for learning are stored in the memory, the generator 121B performs a machine learning algorithm LA by using the first part of the datasets for learning DT thus stored as input data and the second part thereof as training data, thereby generating a model PM that receives the dataset for prediction DP as input and outputs the predicted man-hour value PV2.

If a decision is made that the dataset be used for prediction, then the dataset is stored in a dataset for prediction area (not shown) in the memory. When a predetermined number of datasets for prediction DP are stored in the memory, the predictor 122B performs a prediction algorithm PA based on the model PM thus generated by using the datasets for prediction DP thus stored as input, thereby acquiring one or more predicted man-hour values PV2 for one or more second periods in the future.

When the acceptor 11B accepts a plan creation instruction via an input device, the setter 123B sets a standard man-hour. The creator 124B creates, based on the standard man-hour that has been set, the one or more predicted man-hour values PV2 thus acquired, and two or more pieces of personnel information stored in the memory, an operation plan that allows two or more persons belonging to the personnel to perform the operation in one or more second periods in the future.

The outputter 13B outputs the operation plan thus created. In this case, the operation is performed by the two or more persons belonging to the personnel in accordance with the operation plan thus output. In addition, the operation plan thus output is also passed to the difference detector 2B.

When the acceptor 11B accepts difference information from the difference detector 2B, the updater 125 updates the standard man-hour that has been set based on the difference information thus accepted to narrow the difference between the planned operation and the actual operation.

The difference detector 2B may operate, for example, in the following manner.

The observer 221 that forms part of the difference detector 2B observes, through the camera 3 and the LPS 4, the actual operation being performed following the operation plan created by the plan creator 1B.

The detector 222 detects, based on the operation plan and the result of observation, the difference concerning man-hour between the operation planned by the operation plan and the actual operation, thereby acquiring difference information about the difference thus detected. The outputter 23 outputs the difference information thus acquired. The difference information thus output is passed to the plan creator 1B.

Optionally, based on the difference information thus output, countermeasure information may be entered by, for example, an administrator who manages the operation to narrow the difference. The acceptor 21B may accept the countermeasure information thus entered and the outputter 23 may pass the countermeasure information thus accepted to the plan creator 1B.

### (9) Specific Applications

The target management system 100 described for the first embodiment is applicable to managing, using a target, various types of activities including the physical distribution shown in FIG. 11, the selling shown in FIG. 12, and business management (not shown). Meanwhile, the shelf stocking management system 100A described for the second embodiment and the plan optimization system 100B described for the third embodiment are mainly applicable to selling.

Examples of targets according to the present disclosure include progress information, receiving quantity information, shipment quantity information, quantity of inventory information, shelf stocking related information, and profits.

### (9-1) Application to Physical Distribution

The burden 502 shipped from a factory 501 is transported by the physical distribution shown in FIG. 11 to the store 200 and then passed to the hands of a customer who visits the store 200 by the selling shown in FIG. 12. The burden 502 is transported by a truck 503 from the factory 501 to a warehouse 500 and vice versa. A barcode (not shown) for identifying the burden 502 is affixed to the burden 502. The memory of the target management system 100 stores standard values of various types of targets.

As shown in FIG. 11, the physical distribution is implemented as a combination of a storage department 500A, a picking department 500B, a sorting department 500C, and a shipping department 500D.

### (9-1-1) Storage Department

In the storage department 500A, the acquirer 121 acquires, using a barcode reader (not shown), the value representing the quantity of inventory information and the first output controller 1241a outputs the value thus acquired. This allows either the administrator who manages the physical distribution or the personnel who perform the operation to timely recognize the status of inventory in the warehouse.

In addition, in the storage department 500A, the detector 123 detects the difference between the reference value and the acquired value with respect to the quantity of inventory information and the second output controller 1241b has the difference thus detected output. This allows the personnel to properly recognize the quantity to place an order for.

Furthermore, in the storage department 500A, the updater 1242 updates the standard value with respect to the quantity of inventory information to narrow the difference between the standard value and the acquired value. This allows, even if the standard value about the quantity of inventory information is improper, the improper standard value to be redressed either at once or gradually.

As a result, the inventory may always be maintained in a proper state in the warehouse 500. That is to say, the target management system 100 may help the storage department 500A maintain proper inventory state.

### (9-1-2) Picking Department

In the picking department 500B, the acquirer 121 acquires a value of the progress information via the camera 3 and the first output controller 1241a outputs the acquired value. This allows the progress of the operation to be visualized in real time for each of a plurality of persons belonging to the personnel who are performing the picking operation.

In addition, in the picking department 500B, the detector 123 detects the difference between the standard value and the acquired value with respect to the progress information and the second output controller 1241b has the difference thus detected output. This allows the administrator to recognize the difference between the standard value and the acquired value with respect to each person belonging to the personnel.

Furthermore, in the picking department 500B, the updater 1242 updates the standard value with respect to the progress information to narrow the difference between the standard value and the acquired value. This allows, even if the standard value about the progress information is improper, the improper standard value to be redressed either at once or gradually.

This allows the administrator to recognize the progress of operations with respect to each person belonging to the personnel and appropriately assign the operations to minimize the delay. That is to say, the target management system 100 may help the picking department 500B make the best operation assignment.

### (9-1-3) Sorting Department

In the sorting department 500C, sorting by machine and manual sorting are carried out. The acquirer 121 acquires, using the camera 3, values of progress information with respect to each of sorting by machine and manual sorting and the first output controller 1241a has these two types of acquired values output. This allows the administrator of the sorting department 500C to recognize the progress of the operations with respect to each of sorting by machine and manual sorting.

In addition, in the sorting department 500C, the detector 123 detects the difference between the standard value and the acquired value with respect to each of sorting by machine and manual sorting and the second output controller 1241b has the differences thus detected output. This allows the administrator to extract a bottleneck in the sorting department 500C and redesign the process. In addition, this also allows the two types of sorting to be synchronized with each other, thus increasing the throughput of the overall sorting department 500C.

Furthermore, in the sorting department 500C, the updater 1242 updates the standard value with respect to the progress information about each of sorting by machine and manual sorting to narrow the difference between the standard value and the acquired value. This allows, even if the standard value about the progress information is improper with respect to at least one of sorting by machine or manual sorting, the improper standard value to be redressed either at once or gradually.

As a result, the throughput of the overall sorting department 500C may be maintained at a proper value. That is to say, the target management system 100 may help the overall sorting department 500C maintain a proper throughput

### (9-1-4) Shipping Department

In the shipping department 500D, the acquirer 121 acquires a value of the shipping quantity information via the camera 3 and the first output controller 1241a has the acquired value output. This allows the administrator of the shipping department 500D to recognize the shipment quantity.

Also, in the shipping department 500D, the standard value about the shipment quantity information is set based on the operating status of the trucks 503 (such as the number of trucks 503 available per unit time and the load capacity per truck 503) that transports the burden 502 shipped to the store 200. The detector 123 detects the difference between the standard value and the acquired value with respect to the shipment quantity information and the second output controller 1241b has the difference thus detected output. This allows the administrator to optimize the shipping operation according to the operating status of the trucks 503.

Furthermore, in the shipping department 500D, the updater 1242 updates the standard value with respect to the shipment quantity information to narrow the difference between the standard value and the acquired value. This allows, even if the standard value about the shipment quantity information is improper, the improper standard value to be redressed either at once or gradually.

As a result, the quantity of shipments from the shipping department 500D may be maintained at a proper value according to the operating state of the trucks 503. That is to say, the target management system 100 may help the shipping department 500D maintain a proper shipment quantity.

### (9-2) Application to Selling

The selling is performed by a backroom department 200A and a store department 200B as shown in FIG. 12.

### (9-2-1) Backroom Department

In the backroom department 200A, the acquirer 121 acquires a value of the quantity of inventory information on a product-by-product basis via the camera 3 and the first output controller 1241a has the acquired value output.

In this example, a predetermined number of products of a single type are loaded into a single burden 502. The space inside the backroom is divided into a plurality of compartments, in each of which one or more burdens 502, each loaded with products of a single type, are put. Each of the plurality of compartments is associated with type information indicating the type of the products put in the compartment.

The acquirer 121 detects, based on the image information provided by the camera 3, the number of burdens 502 put in each of the plurality of compartments and acquires the number of products by multiplying the detected number by the predetermined number. Next, the acquirer 121 acquires, with respect to each of the plurality of compartments, the types and number of the products present in the compartment based on the type information associated with the compartment. Then, the acquirer 121 calculates, on a type-by-type basis, the sum of the numbers of products thus acquired.

The first output controller 1241a has the information acquired by the acquirer 121 (i.e., a piece of information indicating the number of products on a type-by-type basis) output. The destination may be the mobile telecommunications devices of the personnel working in the backroom in this example but may also be the terminal device of the administrator who manages the selling.

This allows the quantity of inventory in the backroom to be visualized in real time on a product-by-product basis.

In addition, the detector 123 detects the difference between the standard value and the acquired value on a product-by-product basis with respect to the quantity of inventory information and the second output controller 1241b has the differences thus detected output. This allows the sales administrator to recognize the difference between the standard value and the acquired value on a product-by-product basis with respect to the quantity of inventory information.

Furthermore, in the backroom department 200A, the updater 1242 updates the standard value with respect to the quantity of inventory to narrow the difference between the standard value and the acquired value. This allows, even if the standard value about the quantity of inventory is improper, the improper standard value to be redressed either at once or gradually.

This allows, if there are any out-of-stock products, the administrator to recognize the name and quantity of the out-of-stock products and quickly instruct the personnel to place an order for the products. This also allows, if any products are overstocked, the administrator to recognize the name and quantity of the overstocked products and instruct the personnel to refrain from placing an order for the products or reduce the quantity of the products. That is to say, the target management system 100 may help the backroom department 200A optimize the inventory management.

### (9-2-2) Store Department

In the store department 200B, the acquirer 121 acquires, via the camera 3, a value of the quantity information about the quantity of products displayed on the shelves (hereinafter referred to as “displayed quantity information”) on a product-by-product basis and the first output controller 1241a has the acquired values output. This allows the displayed quantity at the store to be visualized in real time on a product-by- product basis.

In addition, in the store department 200B, the detector 123 detects the difference between the standard value and the acquired value on a product-by-product basis with respect to the displayed quantity information and the second output controller 1241b has the differences thus detected output. This allows the sales administrator to recognize the difference between the standard value and the acquired value on a product-by-product basis with respect to the displayed quantity information.

This allows, if there are products, of which the inventory is running short on the shelves, the administrator to recognize the name and quantity of such products that are running short and to instruct the personnel to timely stock the shelves. That is to say, the target management system 100 may help the store department 200B maintain the best display state, thus reducing the chances of missing the opportunities to sell the products.

In addition, in the store department 200B, the acquirer 121 acquires a value of the visitor information via the camera 3 and the first output controller 1241a has the acquired values output. Note that the visitor information may be the number of visitors information described above but may also be information about their stay time and the sections that they dropped in at. This allows coming and going of the visitors inside the store to be visualized in real time.

In addition, in the store department 200B, the detector 123 detects the difference between the standard value and the acquired value with respect to the visitor information and the second output controller 1241b has the difference thus detected output. This allows the sales administrator to recognize the difference between the standard value and the acquired value in real time with respect to coming and going of the visitors inside the store.

Furthermore, in the store department 200B, the updater 1242 updates the standard value with respect to each of the displayed quantity information and visitor information to narrow the difference between the standard value and the acquired value. This allows, even if at least one of the displayed quantity information or the visitor information is improper, the improper standard value thereof to be redressed either at once or gradually.

Besides, in the store department 200B, the predictor 1243 acquires a predicted value with respect to each of the displayed quantity information and visitor information and passes the predicted values to the acquirer 121. This contribute to improving the accuracy of the acquired value with respect to each of the displayed quantity information and visitor information.

This allows the administrator to appropriately instruct the personnel to wait on the customers (visitors) or stock the shelves preferentially according to the circumstances surrounding the customers or visitors. That is to say, the target management system 100 may help the store department 200B provide proper customer/visitor services, thus contributing to improving the value of the store.

### (9-3) Cooperation Between Departments

The products shipped from the factory are passed to the hands of the visitors by way of the physical distribution (refer to FIG. 11) made up of the storage department 500A, the picking department 500B, the sorting department 500C, and the shipping department 500D and the selling (refer to FIG. 12) made up of the backroom department 200A and the store department 200B.

In other words, a series of operation process steps for delivering products from the factory to the visitors are performed by cooperation between these seven departments, namely, the storage department 500A, the picking department 500B, the sorting department 500C, the shipping department 500D, the backroom department 200A, and the store department 200B.

Thus, the setter 122 sets a standard value for each of these seven departments with respect to a target such as the progress information and the operation efficiency information, the acquirer 121 acquires at least one of an actual value or a predicted value for each of the seven departments, and the detector 123 detects the difference between the acquired value and the standard value for each of the seven departments. The narrowing processor 124 may perform, based on seven differences corresponding to the seven departments, respectively, optimization processing for optimizing a part or all of the series of operation process steps to be performed by the seven departments (e.g., interchanging the personnel, or increasing or decreasing the number of personnel, between a department with low operation efficiency and a department with high operation efficiency).

Alternatively, between the backroom department 200A and the store department 200B (refer to FIG. 12), for example, the narrowing processing may be performed in the following manner as for a target such as the quantity of inventory information. Specifically, the setter 122 may acquire, based on the progress information about the progress of the shelf stocking operation in the backroom department 200A, an ideal quantity of inventory in conjunction with the operation of stocking the shelves in the store department 200B and set the quantity of inventory thus acquired as the standard value of the target.

The acquirer 121 may acquire a value of the target (as an actual value) based on, for example, the image information provided by the camera 3. The detector 123 may detect the difference between the acquired value and the standard value. The narrowing processor 124 may perform narrowing processing to narrow the difference thus detected.

In this manner, the backroom department 200A and the store department 200B may cooperate with each other to optimize the quantity of inventory.

### (9-3-1) Change of Operation Plan Based on Multiple Differences Corresponding to Multiple Departments

Such optimization processing is equivalent to changing the operation plan based on, for example, multiple differences corresponding to multiple departments. The narrowing processor 124 identifies a department (i.e., a bottleneck), of which the difference is significantly greater than that of any other department. The narrowing processor 124 changes the shift plan (that has been described for the third embodiment) and the personnel plan with respect to two or more departments including the department thus identified and one or more department upstream of that department or all the seven departments to narrow the difference in the department thus identified (i.e., to make the seven differences corresponding to the all the seven departments more uniform). In this manner, the narrowing processor 124 optimizes part or all of the series of operation process steps to be performed by the seven departments.

Specifically, if in the shipping department 500D, not every burden 502 is (or is expected to be) ready to ship at the time when the truck 503 is supposed to start, for example, then the narrowing processor 124 may change the shift plan and the personnel plan with respect to the shipping department 500D and the picking department 500B and sorting department 500C upstream of the shipping department 500D to optimize a series of operation process steps to be performed by these three departments.

### (9-3-2) Providing Information From Department With Less Significant Difference to Department With More Significant Difference

Alternatively, the optimization processing described above may also be, for example, providing information from a department with a less significant difference to a department with a more significant difference. Examples of the information to provide include the countermeasure information already described for the third embodiment (such as information about the operation plan or management method or an instruction on an increase or decrease in the number of personnel or change of their assignment).

Specifically, the second output controller 1241b may make the outputter 13 output, for example, countermeasure information including pieces of information about Stores B and C with less significant differences along with the quantity of inventory shown in FIG. 6.

Alternatively, the narrowing processor 124 may create, based on pieces of information about Stores B and C with less significant differences, an instruction on an increase or decrease in the number of personnel or change of their assignment with respect to each of Stores A, D, and E with more significant differences. The three instructions thus created with respect to the three stores (namely, Stores A, D, and E) are passed to the second output controller 1241b. In response, the second output controller 1241b has countermeasure information, further including an instruction for each store, transmitted to each of Stores A, D, and E.

Thus, the operation process steps at each of Stores A, D, and E with more significant differences may be changed in accordance with either the information about Stores B and C with less significant differences or the instructions.

### (9-4) Application To Business Management (Cooperation Between Field Layer and Business Management Layer)

The storage department 500A, the picking department 500B, the sorting department 500C, the shipping department 500D, the backroom department 200A, and the store department 200B all belong to the field layer.

The acquirer 121 acquires, based on the image information provided by the camera 3, the first value of the man-hour as the first target with respect to each of one or more departments selected from the group consisting of the storage department 500A, the picking department 500B, the sorting department 500C, the shipping department 500D, the backroom department 200A, and the store department 200B.

The setter 122 sets a first standard value (standard man-hour) with respect to each of the one or more departments for which the acquirer 121 acquires the first value. In addition, the setter 122 also sets, based on one or more first standard values for the one or more departments and the sales information, a second standard value of the profit rate as the second target.

The detector 123 detects a first difference between a first acquired value concerning the man-hour and the first standard value with respect to each of the one or more departments.

The acquirer 121 acquires a second value of the profit rate based on one or more first values for the one or more departments, one or more first differences for the one or more departments, and a second standard value concerning the profit rate.

The detector 123 detects a second difference between a second acquired value concerning the profit rate and the second standard value with respect to each of the one or more departments.

The narrowing processor 124 performs first narrowing processing to narrow the first difference based on the second difference. In this example, when the second difference exceeds a predetermined threshold value, the second output controller 1241b has one or more first differences for the one or more departments output.

This allows the manager to identify, based on the one or more first differences that have been output, a department as a root cause of the increase in the second difference, among the one or more departments and instruct the department thus identified to follow the countermeasure for narrowing the first difference.

Consequently, the activity including physical distribution, selling, and business management may be managed appropriately using the target

### (10) Target Management Method and Program

The functions of each of the target management system 100 according to the first embodiment, the shelf stocking management system 100A according to the second embodiment, and the plan optimization system 100B according to the third embodiment may also be implemented as a target management method, a (computer) program, or a non-transitory storage medium that stores the program thereon. Note that the target management method is a method including at least Step S4 (acquisition step), Step S2 (setting step), and Step S7 (narrowing processing step) among the various process steps described above with reference to the flowchart of FIG. 2. The program is designed to cause a computer to perform this target management method.

### (11) Recapitulation

A target management system (100, 100A, 100B) according to a first aspect includes an acquirer (121, 121A, 221) and a processor (124, 12A, 12B). The acquirer (121, 121A, 221) acquires, over a first period including a plurality of time frames in which a plurality of operations are performed, an actual value of man-hour of each of the plurality of operations. The processor (124, 12A, 12B) calculates a difference between the actual value of the man-hour of each of the plurality of operations to be performed in the first period and a preset standard man-hour and updates the standard man-hour to narrow the difference in a second period following the first period. The processor (124, 12A, 12B) acquires, with respect to an item of operation identical with the man-hour acquired in the first period, a predicted man-hour value for the second period based on a dataset for prediction including period identification information, period attribute information, and quantity information. The processor (124, 12A, 12B) creates an operation plan for the second period based on the standard man-hour that has been updated, the predicted man-hour value, and personnel information about personnel including a worker who performs the plurality of operations in the second period.

In a target management system (100, 100A, 100B) according to a second aspect, which may be implemented in conjunction with the first aspect, the processor (124, 12A, 12B) outputs a plurality of the differences calculated over the plurality of time frames to a display device (display) to make the plurality of differences comparable with each other.

In a target management system (100, 100A, 100B) according to a third aspect, which may be implemented in conjunction with the first or second aspect, the processor (124, 12A, 12B) detects a variation in the difference by changing, to a predetermined amount every time, the standard man-hour in a plurality of the second periods following the first period.

In a target management system (100, 100A, 100B) according to a fourth aspect, which may be implemented in conjunction with any one of the first to third aspects, the processor (124, 12A, 12B) updates, when finding the difference greater than a predetermined threshold value, the standard man-hour to narrow the difference, but keeps, when finding the difference equal to or less than the predetermined threshold value, the standard man-hour non-updated.

In a target management system (100) according to a fifth aspect, which may be implemented in conjunction with any one of the first to fourth aspects, the acquirer (121, 121A, 221) acquires either image information or location information about the plurality of operations to be performed in the first period. The processor (124, 12A, 12B) calculates, based on either the image information or the location information, the difference with respect to the man-hours of the plurality of operations.

In a target management system (100, 100A, 100B) according to a sixth aspect, which may be implemented in conjunction with the fifth aspect, the processor (124, 12A, 12B) outputs the difference, the image information, or the location information to a display device (display) and accepts an instruction to narrow the difference from an input device.

In a target management system (100, 100A, 100B) according to a seventh aspect, which may be implemented in conjunction with any one of the first to sixth aspects, the period identification information is a piece of information to identify either a date or a time frame.

In a target management system (100, 100A, 100B) according to an eighth aspect, which may be implemented in conjunction with any one of the first to seventh aspects, the period attribute information is a piece of information about any one of a day of the week, a bargain day, a non-business day, or bargain hours.

In a target management system (100, 100A, 100B) according to a ninth aspect, which may be implemented in conjunction with any one of the first to eighth aspects, the quantity information is a piece of information including any one of number of visitors information, receiving quantity information, shipment quantity information, or handleable quantity information about articles.

In a target management system (100, 100A, 100B) according to a tenth aspect, which may be implemented in conjunction with any one of the first to ninth aspects, the processor (124, 12A, 12B) outputs, every time the acquirer (121, 121A, 221) acquires a value about the man-hour, the value about the man-hour to a display device (display).

In a target management system (100, 100A, 100B) according to an eleventh aspect, which may be implemented in conjunction with any one of the first to tenth aspects, the plurality of operations are a series of operations that are continuous with each other. The processor (124, 12A, 12B) identifies an operation having a greater difference than any other operation out of the plurality of operations to be performed in the first period and changes, with respect to the operation plan for the second period, either the operation plan or personnel assignment for at least the operation identified and one or more operations upstream of the operation identified to narrow the difference for the operation identified in the second period.

In a target management system (100, 100A, 100B) according to a twelfth aspect, which may be implemented in conjunction with any one of the first to eleventh aspects, the processor (124, 12A, 12B) acquires, in the first period, an actual management value for a predetermined management indicator with respect to a plurality of departments on a department-by-department basis. The processor (124, 12A, 12B) calculates a second difference between the predetermined management indicator and the actual management value in the first period on the department-by-department basis. The processor (124, 12A, 12B) outputs the difference to a display device (display) with respect to at least one department, of which the second difference is equal to or greater than a threshold value, out of the plurality of departments.

A target management method according to a thirteenth aspect includes an acquisition step (S4) and a processing step (S6, S7). The acquisition step (S4) includes acquiring, over a first period including a plurality of time frames, a value of man-hour of each of a plurality of operations. The processing step (S6, S7) includes calculating a difference between an actual value of the man-hour of each of the plurality of operations to be performed in the first period and a preset standard man-hour and updating the standard man-hour to narrow the difference in a second period following the first period. The processing step (S6, S7) also includes acquiring, with respect to an item of operation identical with the man-hour acquired in the first period, a predicted man-hour value for the second period based on a dataset for prediction including period identification information, period attribute information, and quantity information. The processing step (S6, S7) further includes creating an operation plan for the second period based on the standard man-hour that has been updated, the predicted man-hour value, and personnel information about personnel including a worker who performs the plurality of operations in the second period.

A non-transitory storage medium (disc) according to a fourteenth aspect stores thereon a program designed to cause one or more processors to perform the target management according to the thirteenth aspect.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

1. A target management system comprising:
an acquirer configured to acquire, over a first period including a plurality of time frames in which a plurality of operations are performed, an actual value of man-hour of each of the plurality of operations; and
a processor,
the processor being configured to:
calculate a difference between the actual value of the man-hour of each of the plurality of operations to be performed in the first period and a preset standard man-hour and update the standard man-hour to narrow the difference in a second period following the first period;
acquire, with respect to an item of operation identical with the man-hour acquired in the first period, a predicted man-hour value for the second period based on a dataset for prediction including period identification information, period attribute information, and quantity information; and
create an operation plan for the second period based on the standard man-hour that has been updated, the predicted man-hour value, and personnel information about personnel including a worker who performs the plurality of operations in the second period.

2. The target management system of claim 1, wherein
the processor is configured to output a plurality of the differences calculated over the plurality of time frames to a display device to make the plurality of differences comparable with each other.

3. The target management system of claim 1, wherein
the processor is configured to detect a variation in the difference by changing, to a predetermined amount every time, the standard man-hour in a plurality of the second periods following the first period.

4. The target management system of claim 2, wherein
the processor is configured to detect a variation in the difference by changing, to a predetermined amount every time, the standard man-hour in a plurality of the second periods following the first period.

5. The target management system of claim 1, wherein
the processor is configured to, when finding the difference greater than a predetermined threshold value, update the standard man-hour to narrow the difference, and also configured to, when finding the difference equal to or less than the predetermined threshold value, keep the standard man-hour non-updated.

6. The target management system of claim 2, wherein
the processor is configured to, when finding the difference greater than a predetermined threshold value, update the standard man-hour to narrow the difference, and also configured to, when finding the difference equal to or less than the predetermined threshold value, keep the standard man-hour non-updated.

7. The target management system of claim 3, wherein
the processor is configured to, when finding the difference greater than a predetermined threshold value, update the standard man-hour to narrow the difference, and also configured to, when finding the difference equal to or less than the predetermined threshold value, keep the standard man-hour non-updated.

8. The target management system of claim 1, wherein
the acquirer is configured to acquire either image information or location information about the plurality of operations to be performed in the first period, and
the processor is configured to calculate, based on either the image information or the location information, the difference with respect to the man-hours of the plurality of operations.

9. The target management system of claim 2, wherein
the acquirer is configured to acquire either image information or location information about the plurality of operations to be performed in the first period, and
the processor is configured to calculate, based on either the image information or the location information, the difference with respect to the man-hours of the plurality of operations.

10. The target management system of claim 3, wherein
the acquirer is configured to acquire either image information or location information about the plurality of operations to be performed in the first period, and
the processor is configured to calculate, based on either the image information or the location information, the difference with respect to the man-hours of the plurality of operations.

11. The target management system of claim 4, wherein
the acquirer is configured to acquire either image information or location information about the plurality of operations to be performed in the first period, and
the processor is configured to calculate, based on either the image information or the location information, the difference with respect to the man-hours of the plurality of operations.

12. The target management system of claim 8, wherein
the processor is configured to output the difference, the image information, or the location information to a display device, and accept an instruction to narrow the difference from an input device.

13. The target management system of claim 1, wherein
the period identification information is a piece of information to identify either a date or a time frame.

14. The target management system of claim 1, wherein
the period attribute information is a piece of information about any one of a day of the week, a bargain day, a non-business day, or bargain hours.

15. The target management system of claim 1, wherein
the quantity information is a piece of information including any one of number of visitors information, receiving quantity information, shipment quantity information, or handleable quantity information about articles.

16. The target management system of claim 1, wherein
the processor is configured to, every time the acquirer acquires a value about the man-hour output the value about the man-hour to a display device.

17. The target management system of claim 1, wherein
the plurality of operations are a series of operations that are continuous with each other, and
the processor is configured to identify an operation having a greater difference than any other operation out of the plurality of operations to be performed in the first period and change, with respect to the operation plan for the second period, either the operation plan or personnel assignment for at least the operation identified and one or more operations upstream of the operation identified to narrow the difference for the operation identified in the second period.

18. The target management system of claim 1, wherein
the processor is configured to:
acquire, in the first period, an actual management value for a predetermined management indicator with respect to a plurality of departments on a department-by-department basis;
calculate a second difference between the predetermined management indicator and the actual management value in the first period on the department-by-department basis; and
output the difference to a display device with respect to at least one department, of which the second difference is equal to or greater than a threshold value, out of the plurality of departments.

19. A target management method comprising:
an acquisition step including acquiring, over a first period including a plurality of time frames, a value of man-hour of each of a plurality of operations; and
a processing step,
the processing step including:
calculating a difference between an actual value of the man-hour of each of the plurality of operations to be performed in the first period and a preset standard man-hour and updating the standard man-hour to narrow the difference in a second period following the first period;
acquiring, with respect to an item of operation identical with the man-hour acquired in the first period, a predicted man-hour value for the second period based on a dataset for prediction including period identification information, period attribute information, and quantity information; and
creating an operation plan for the second period based on the standard man-hour that has been updated, the predicted man-hour value, and personnel information about personnel including a worker who performs the plurality of operations in the second period.

20. A non-transitory storage medium storing thereon a program designed to cause one or more processors to perform the target management of claim 19.
